(19) United States
(12) Patent Application Publication
(10) Pub. No.: US 2006/0198382 A1
(43) Pub. Date: Sep. 7, 2006

(54) Communication node, communication network and method for updating database

(75) Inventors: Kazuhiko Sagara, Kodaira (JP); Ryouji Yamaoka, Mitaka (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/352,287

(22) Filed: Feb. 13, 2006

(30) Foreign Application Priority Data
Mar. 7, 2005 (JP) 2005-062072
Dec. 27, 2005 (JP) 2005-376177

(51) Int. Cl. H04Q 7/24; H04L 12/56; H04L 12/28

(52) U.S. Cl. 370/400; 370/338

(57) ABSTRACT

Authentication databases are exchanged by using a movement signal of a terminal as a trigger. Newly registered data is stored in an authentication database as differential data. As a result, at a time point when at least one terminal out of terminals to which new information has been registered moves from a domain to another, synchronization processing of the authentication databases will occur. For this reason, at a time point when a terminal reaches the destination, registration data of the terminal is already transferred to the authentication database at the destination, thus enabling to initiate communication without making new registration at the destination.

### CLAIM OF PRIORITY

The present application claims priority from Japanese patent application Ser. Nos. 2005-062072, filed on Mar. 7, 2005 and 2005-376177, filed on Dec. 27, 2005, the contents of which are hereby incorporated by reference into this application.

### BACKGROUND OF THE INVENTION

The present invention relates to a communication network system that executes authentication for each domain. More specifically, the invention relates to a communication node, communication network and a method for updating database, wherein, when a terminal moves between two domains, an authentication database is updated based on a domain movement signal, thus enabling an improvement in identity of the authentication database.

The present invention further relates to a communication system that executes authentication in units of domain, and more specifically to a communication system, wherein, when requests for authentication reach to a communication node in the amount that exceeds the processing capacity of a communication node, another communication node carries out authentication for that communication node.

A ubiquitous network is expected to have a mode in which terminals on the order of one million units repeat participation in and pulling out from the network per second to use information distribution services or pier-to-pier services. In addition, since a terminal has a high mobility and is connected to an access point by wireless, it is likely to be subjected to fraudulent attacks from outside sources. For this reason, a ubiquitous network requires an authentication function for each terminal to ensure security thereof. However, when authentication is carried out for each terminal with a single server of a network, a delay in processing time will occur due to concentrated authentication traffics.

To solve the problem, a decentralized type of authentication system is proposed in Japanese Laid-Open Patent Publication No. 2005-244405. This publication states that an authentication control agent is allocated for each domain and authentication is performed in units of domain. In other words, for terminals within a domain, concentration of traffics can be avoided since an authentication control agent which functions in conjunction with a communication node will perform alternate processing, thus enabling high-speed authentication processing. Further, the communication node holds an authentication database, and processing to synchronize statuses of authentication databases among a plurality of communication nodes included in the core network is realized.

With a decentralized type of authentication system, an authentication control agent (hereafter AGT) which is a communication node is allocated in units of domain to perform authentication for each domain. In other words, since the AGT carries out authentication for terminals within a domain, it is possible to prevent concentration of authentication traffics, thus enabling faster authentication processing. Here, a domain implies an administrative unit of a network, and a typical example thereof is a local unit.

In addition, the AGT which is a communication node holds an authentication database within the AGT, and processing is realized for synchronizing status of authentication database among a plurality of communication nodes included in the core network.

US 2005/0232263 A1 is a counterpart application of JP 2005-244405 A.

In Non-patent Reference 1, the progress status of studies of a ubiquitous network authentication and agent technology group is stated.

[Non-Patent Reference 1]

Hitachi, Ltd., the University of Tokyo, Nippon Telegraph and Telephone Corporation, and Osaka University, “Ubiquitous network authentication and agent technology outline”, Nov. 29 to 30, 2004, Ubiquitous Authentication Agent Group, P. 5.

In the environment for the usage where many information terminals are connected to a network, not only such existing terminals whose data required for authentication has already been registered in an authentication database, but also many new terminals whose data has not been registered yet will participate in the network. Therefore, the status of the authentication database varies from hour to hour, since, for such new terminals, data registration is carried out in real time. On the other hand, a user moves from a domain to another domain at high speed, while carrying an information terminal with the user. At this time, the user wishes to immediately start communication even at the movement destination without re-registering data required for authentication. In addition, since data volume of the authentication database is enormous, it is difficult to identify the authentication databases in the whole network within a short period of time, and a system that transfers the authentication database after reducing the volume is required.

In the conventional decentralized type of authentication, synchronization of an authentication database is performed in units of new registration and it is not synchronized with shifting of a terminal. Therefore, when a terminal shifts, there is no guarantee that the authentication database at the movement destination and the authentication database before the shift are the same. In addition, when synchronization is performed in units of new registration, useless traffics occur. Further, the conventional decentralized type of authentication has a problem in that, since data volume of the authentication database is huge, transmission of information of all the authentication databases to a communication node at the movement destination presses traffics, thus causing deteriorated efficiency of use of a network.

In a ubiquitous network, a terminal moves from a domain to another, which generates deviation in the number of terminals that are located in each domain.

The AGT which executes authentication processing in a domain with concentrated terminals poses a problem in that load on a CPU increases and thus time required for authentication processing also increases, which decreases access processing capability (access throughput) of the entire network.

### SUMMARY OF THE INVENTION

An object of the present invention is to provide a communication node, a communication network system and a method for updating database which enable to initiate communication at the time of handover without allowing a user to register terminal information anew at the movement destination.

Another object of the present invention is to provide a communication node and a communication system which will not deteriorate the access throughput of the entire network even when requests for authentication has reached to a communication node in the amount exceeding the processing capability thereof.

To achieve the object stated above, the present invention executes transfer of an authentication database by using a shift signal (a message to change the transfer destination) of the terminal as a trigger. In addition, new registration data is stored in the authentication database as differential data. As a result, since synchronization processing occurs at a point when a terminal that has registered new information makes a domain shift, registration data of the terminal has been transferred to the authentication database at the movement destination when the terminal reaches the movement destination. Therefore, a user can initiate communication at the movement destination without making a new registration anew. In addition, since the new registration data is stored as differential data and the differential data is transferred in bulk as block data, it is possible to reduce traffic volume, thus enabling to realize synchronization at high speed.

According to an aspect of the present invention, there is provided a communication system, which includes a plurality of communication nodes each incorporating a processor that executes authentication processing according to an authentication request from a terminal, the communication nodes being connected logically with one another. The communication system is characterized in that the communication nodes includes a first communication node that receives the authentication request and a second communication node that is connected logically to the first communication node; and the first communication node, upon receiving an authentication request from the terminal, judges the load status of the processor of the first communication node and transfers the authentication request to the second communication node if the processor is in a high-load status, or executes authentication processing from the terminal within the node if the processor is in a low-load status.

According to the aspect of the present invention, it is possible to prevent deterioration in access throughput of the entire network even if the number of simultaneous accesses has increased. Further, by effectively utilizing network resources, it is possible to realize reduction in operation costs.

Other problems, features and operation modes that are to be solved by the present invention will be more clearly understood from the description of the preferred embodiments which follow with reference to the accompanying drawings.

### BRIEF DESCRIPTION OF THE DRAWINGS

Preferred embodiments of the present invention will now be described in conjunction with the accompanying drawings, in which:

FIG. 1 is a block diagram that describes a configuration showing a network system of a first embodiment;

FIG. 2 is a block diagram that describes a configuration of a communication node;

FIG. 3 is a transition diagram that describes operations of apparatuses of the network system illustrated in FIG. 1;

FIG. 4 is a flow chart for a before-movement terminal;

FIG. 5 is a flow chart for after-movement terminal;

FIG. 6 is a flow chart for a communication node that received a participation request;

FIG. 7 is a flow chart for a communication node of a terminal at a movement destination;

FIG. 8 is a flow chart for a communication node of a terminal at a movement source;

FIG. 9 is a flow chart of reception operations of an HA;

FIG. 10 is a block diagram for describing a logic structure of an authentication database;

FIG. 11 is a block diagram for illustrating a method for updating an authentication database;

FIG. 12 is a block diagram for illustrating another method for updating an authentication database;

FIG. 13 is a block diagram for illustrating still another method for updating an authentication database;

FIG. 14 is a block diagram that describes a configuration showing a network system of a preferred embodiment 2;

FIG. 15 is a transition diagram for describing operations of apparatuses of the network illustrated in FIG. 14;

FIG. 16 is a system configuration diagram of a communication system;

FIG. 17 is a diagram illustrating zones;

FIG. 18 is a block diagram illustrating a configuration of an AGT;

FIG. 19 is a diagram illustrating flows of a request packet and an ACK packet.

FIG. 20A is a configuration diagram of an event control table;

FIG. 20B is a configuration diagram of an event control table;

FIG. 20C is a configuration diagram of an event control table;

FIG. 21 is a transition diagram illustrating operations of a terminal and AGTs;

FIG. 22 is a diagram illustrating a flow chart of an authentication control agent program of an AGT;

FIG. 23 is a diagram illustrating flows of a retrieval query and a response packet;

FIG. 24 is a diagram illustrating flows of a request packet and an ACK packet;

FIG. 25 is a configuration diagram of a retrieval table;

FIG. 26 is a transition diagram illustrating operations of a terminal and AGTs;

FIG. 27 is a diagram illustrating a flow chart of an authentication control agent program of an AGT;

FIG. 28 is a diagram illustrating flows of a query packet and a response packet;

FIG. 29 is a block diagram illustrating a configuration of an AGT control node;

FIG. 30 is a configuration diagram of a CPU control table;

FIG. 31 is a transition diagram illustrating operations of a terminal, AGTs and an AGT control node;

FIG. 32 is a diagram illustrating a flow chart of an authentication agent program of an AGT;

FIG. 33 is a flow chart illustrating processes executed by an AGT control node;

FIG. 34 is a system configuration of a communication system; and

FIG. 35 is a transition diagram illustrating operations of a terminal, AGTs and an AGT control node.

### DESCRIPTION OF THE PREFERRED EMBODIMENTS

Hereinafter, preferred embodiments of the present invention will be described with reference to the accompanying drawings. Note that like elements are given like reference numerals, and descriptions thereof will not be repeated.

[Embodiment 1]

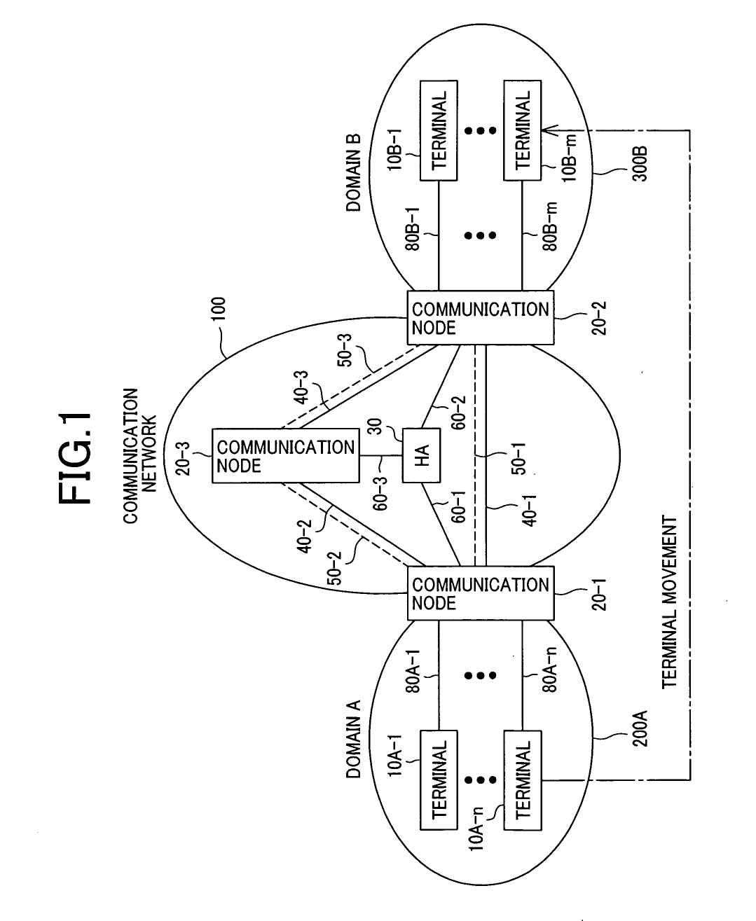

FIG. 1 illustrates the configuration of a network in which a communication network 100 is connected to domains 200A and 300B. For the Layer 3 protocol, the mobileIPv6 (version 6) which is standardized by the IETF (International Engineering Task Force) will apply. Communication apparatuses 20-1, 20-2 and 20-3 as well as an HA (Home Agent) 30 belong to the communication network 100, and the communication nodes 20-1, 20-2 and 20-3 are connected to the HA 30 through communication lines 60-1, 60-2 and 60-3, respectively. In addition, the three communication nodes are connected to one another through data channels 40-1, 40-2 and 40-3 which transfer a data signal, and through authentication channels 50-1, 50-2 and 50-3 which transfer a control signal used for synchronization, etc. of an authentication DB (Data Base) that is incorporated in each of the above-stated communication nodes.

Terminals 10 (10A-1 to 10A-n) belongs to the domain 200A, and other terminals 10 (10B-1 to 10B-m) belongs to the domain 300B. Each terminal (10A-1 to 10A-n) is connected to the communication node 20-1 via communication lines 80 (80A-1 to 80A-n) and each terminal (10B-1 to 10B-m) is connected to the communication node 20-2 via communication lines 80 (80B-1 to 80B-m). With the embodiment, a wireless LAN (IEEE802.11) is applied to the communication lines 80.

A user moves around with the terminal 10A-n and participates in the domain 200A. At this time, the terminal 10A-n carries out authentication with the communication node 20-1, and communication with the communication network 100 becomes possible when the authentication is approved. When the authentication is not approved, the terminal 10A-n registers terminal information with the communication node 20-1 and repeats registration processes until the authentication is approved. The terminal 10A-n for which the authentication is once approved can move around with the communication on-going while the terminal 10A-n remains belonging to the domain 200A.

However, when the terminal 10A-n moves to the domain 300B from the domain 200A, it is normally necessary to carry out authentication again at the moving destination, or in the domain 300B. It should be noted that, with the embodiment, a description will be made assuming that the terminal 10A-n before movement and the terminal 10B-m at the moving destination are the same. The terminal 10 is under control of a communication node 20 which controls the domain concerned.

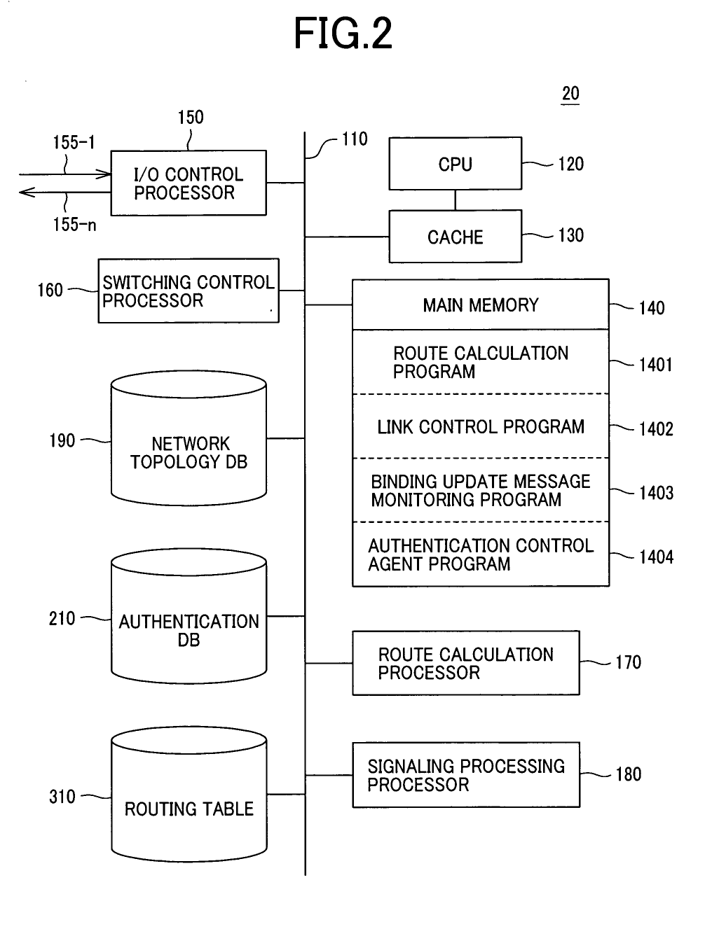

FIG. 2 is a block diagram for describing the system configuration of communication nodes 20-1, 20-2 and 20-3. The communication node 20 includes a CPU (processing unit) 120, a cache memory 130, a main memory 140, an I/O control processor (I/O controller) 150, a switching control processor (switch controller) 160, a route calculation processor (route calculation unit) 170, a signaling processing processor (signal processor) 180, a network topology DB 190, an authentication DB 210 and a routing table 310, and all of such components are connected to a bus 110. The main memory 140 is adapted to store therein a route calculation program 1401, a link control program 1402, a binding update message monitoring program 1403 and an authentication control agent program 1404, and such programs are executed by respective processors. Note that the routing table 310 may be included in the main memory 140.

The I/O control processor 150 is connected to the data channels 40 and the authentication channels 50 via signal control lines 155 (155-1 to 155-n) to control signal flows between opposing communication nodes. In addition, the switching control processor 160 is connected to switching elements (not shown) of communication nodes to control signal flows between ports. The route calculation processor 170 determines the optimal route of a packet by referring to the network topology DB 190 and the routing table 310. The signaling processing processor 180 sets a communication route of the packet based on the calculation result.

The binding update message monitoring program 1403 monitors a binding update message (BU message) that is transmitted from the terminals 10 and transfers the BU message to the HA 30 after adding accompanying information. An authentication DB 210 is adapted to store therein authentication information, etc. of terminals included in a domain for referral when the terminals is authenticated. In addition, the authentication control agent program 1404 monitors a control message concerning terminal authentication.

It should be noted that, as is clear from FIG. 2, the communication node 20 is an apparatus wherein an authentication DB, a binding update message monitoring program and an authentication control agent program are added to a router for enhancement thereof. Alternatively, a switch, other than a router, may be enhanced.

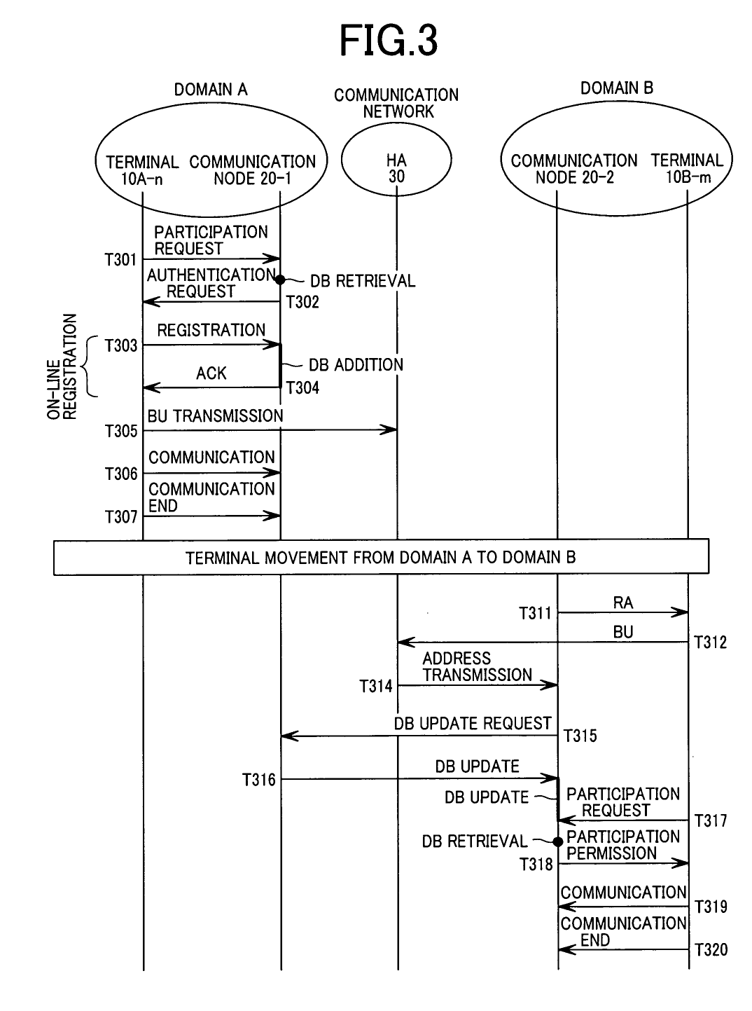

FIG. 3 is a transition diagram which describes operations of apparatuses of the network system illustrated in FIG. 1. First, the terminal 10A-n in a domain A transmits a participation request to the communication node 20-1 (T301). The communication node 20-1 which received the participation request, after retrieval of the authentication DB 210 and confirming that the terminal 10A-n is not registered, returns an authentication request to the terminal 10A-n (T302). In response to this, the terminal 10A-n transmits a registration message (T303). The communication node 20-1 which received the message writes the registration content in the authentication DB 210. Next, the communication node 20-1 transmits an ACK (Acknowledge) message to the terminal 10A-n (T304). This completes the on-line registration.

The terminal 10A-n which received ACK transmits a BU message containing address information on the terminal 10A-n and a communication node 20-1 to the HA 30 (T305). The HA 30 which received the BU message records the address information on the terminal 10A-n and the communication node 20-1 in the address control table. Thereafter, the terminal 10A-n transmits a communication message via the communication node 20-1 (T306) and initiates communication with a server (not shown) that is included in the communication network 100.

The description will be continued assuming that the terminal 10A-n moves from the domain A to a domain B after a while. Before making a move, the terminal 10A-n transmits a communication end message to the communication node 20-1 (T307). At a movement destination, a terminal 10B-m (the terminal 10A-n before the movement) receives an RA (Router Advertisement) from the communication node 20-2 (T311). In this case, since the prefix is different from the one of its own, the terminal 10B-m generates CoA (Care of Address) and transmits a BU message containing the CoA and address information on the terminal 10B-m to the HA 30 (T312). Thereafter, the HA 30 compares the terminal address contained in the received message and the information pre-recorded in the address control table, determines an address of communication node before the terminal movement, and transmits the address to the communication node 20-2 (T314).

Thereafter, the communication node 20-2 in the domain B transmits a DB update request message to the address of the communication node 20-1 in the domain A which was a domain before the terminal 10B-m moved (T315). Being triggered by the reception of the request message, the communication node 20-1 transmits a DB update message which contains the content of new registration to the authentication DB 210 to the communication node 20-2 (T316). The communication node which received the Update message updates the content of the authentication DB of its own.

Next, the terminal 10B-m transmits a participation request to the communication node 20-2 (T317). Since the communication node 20-2 has updated the content of the authentication DB 210 and owns data on the terminal 10B-m (terminal 10A-n) which is already registered on-line in the domain A, the communication node 20-2 transmits a participation permit to the terminal 10B-m (T318). In response to this, the terminal 10B-m transmits a communication message signal and resumes communication with the server included in the communication network 100 (T319).

Here, the method for registration to the authentication DB 210 is explained by way of example of the method for on-line registration wherein registration information is transmitted from a terminal. However, another method is possible in which a network administrator will directly communicate with the communication node 20-1 and add information on a terminal that participated in the domain anew. The same method will apply to other embodiments.

For a method for investigating an address of a communication node which controls the before-movement domain of the terminal 10B-m which made a movement to a new domain, a method for making an inquiry to the HA 30 has been described here. However, the inquiry may be made by including an address of the communication node which controls the before-movement domain of the terminal 10B-m in the terminal 10B-m.

Conversely, a DB update request message may be transmitted to the other communication nodes without the retrieval of the address of the communication node which controls the before-movement domain. Alternatively, the address of a communication node which is under communication processing may be acquired before a terminal transmits a communication end message to a communication node, and the message may be transmitted after movement of the terminal by adding the before-movement address information on the communication node to the BU.

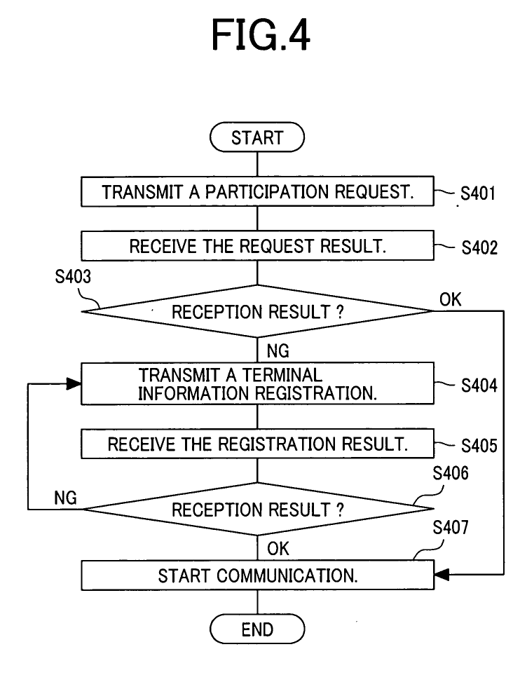

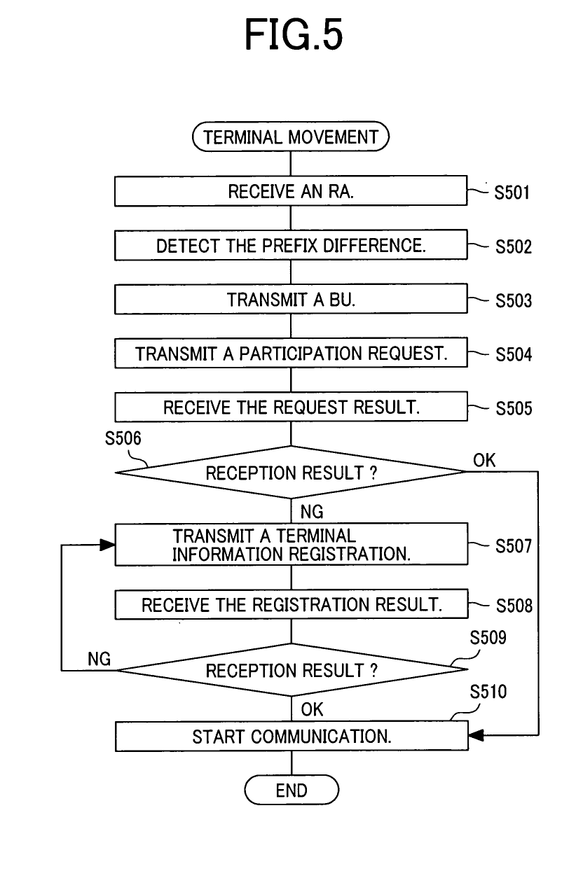

Hereinafter, operation flows of the terminal 10 will be described with reference to FIGS. 4 and 5. Here, FIG. 4 illustrates operations of the before-movement terminal 10A-n, and FIG. 5 illustrates operations of the after-movement terminal 10B-m.

Referring to FIG. 4, the terminal 10A-n first transmits a participation request (S401). Next, the terminal 10A-n receives the result of the request (S402), and judges the reception result (S403). When the reception result is OK (participation permitted), the process advances to communication in Step 407. If the reception result is NG (authentication requested), the terminal 10A-n transmits a terminal information registration (S404), then receives the registration result (S405), and judges the reception result (S406). When the reception result is. OK (ACK), the process advances to communication in Step 407. If the reception result is NG, the process returns to Step 404, and the terminal 10A-n transmits a terminal information registration again. The terminal 10A-n repeats the steps 404 to 406 until the processes end up successfully. Note that, however, the upper limit of the number of trial runs will be set, and if the processes cannot be ended up successfully within the limited number of trial runs, the processes will be treated as time out.

Referring to FIG. 5, the terminal 10B-m which moved from a domain to another receives an RA (S501), compares the prefix with the prefix of its own for detection of difference (S502). Based on the detection of difference, the terminal 10B-m transmits a BU (S503). Thereafter, the terminal 10B-m executes authentication processing at the moving destination, or in the domain B. First, the terminal 10B-m transmits a participation request (S504) and receives the request result (S505). Next, the terminal 10B-m judges the reception result (S506). When the reception result is OK (participation permitted), the process advances to communication in Step 510. If the reception result is NG (authentication requested), the terminal 10B-m transmits a terminal information registration again (S507) and receives the registration result (S508). The terminal 10B-m judges the reception result (S509), and, if the result is OK (ACK), the process advances to communication in Step 510. If the judgment result is NG, the process returns to Step 507 and the terminal registration processes are repeated. At this time, the given number of trial runs is set, and, if the number of trial runs thus set is exceeded, the processes will be treated as time out.

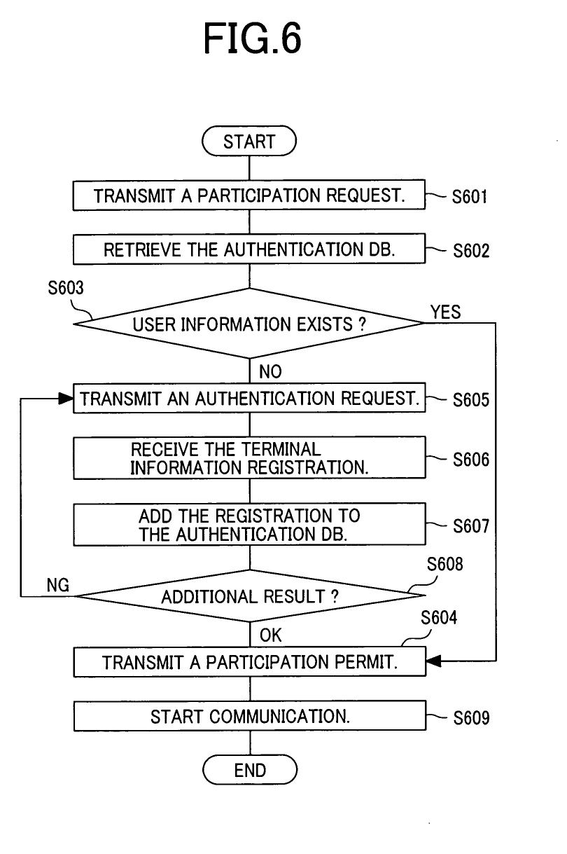

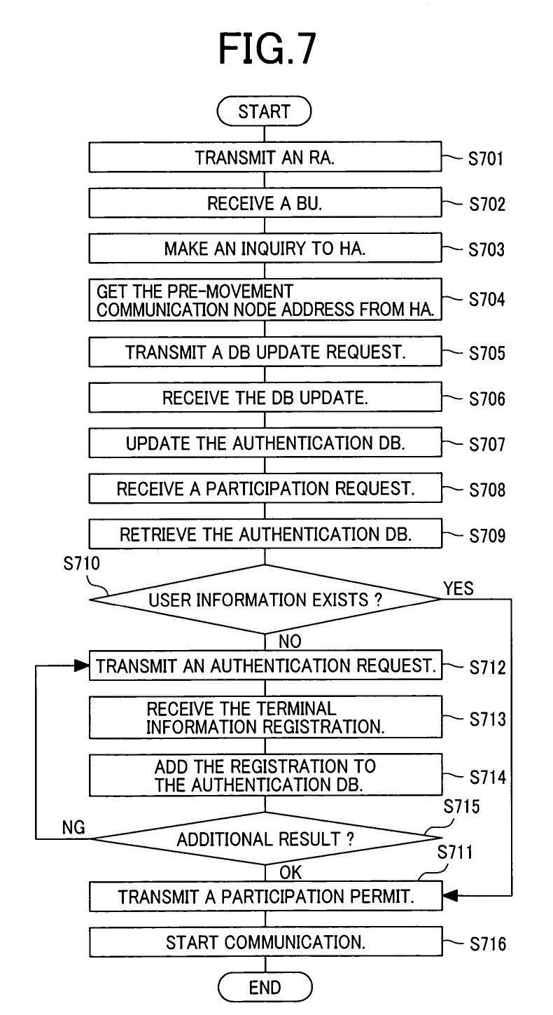

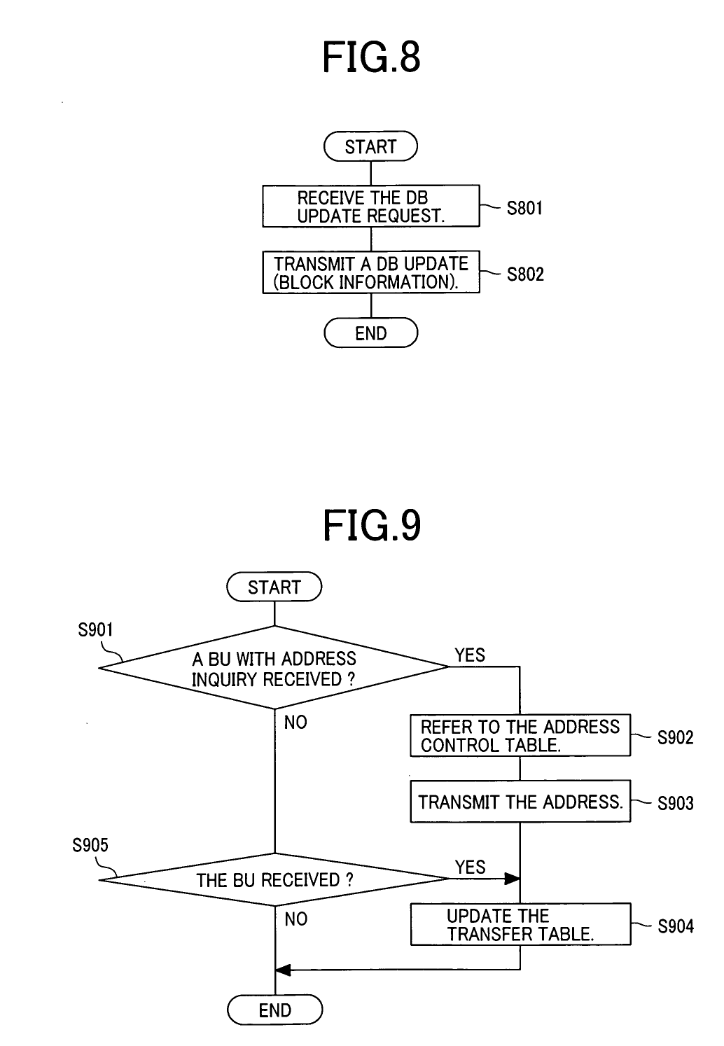

Hereinafter, operation flows of the communication node 20 will be described with reference to FIGS. 6 to 8. Here, FIG. 6 illustrates a flow chart of a communication node that received a participation request, FIG. 7 illustrates a flow chart of a communication node at the moving destination of a terminal, and FIG. 8 illustrates a flow chart of a communication node at the movement source of a terminal.

Referring to FIG. 6, the communication node 20-1 first initiates reception of a packet and receives a participation request (S601). Then, the communication node 20-1 retrieves the authentication DB (S602), and judges whether the content of the packet received is included in the authentication DB 210 or not (S603). When user information is included in the authentication DB 210 (YES), the communication node 20-1 transmits a participation permit (S604). If user information is not included (NO), the communication node 20-1 transmits an authentication request (S605). Then, the communication node 20-1 receives a terminal information registration (S606) and adds the registration to the authentication DB (S607). Thereafter, the communication node 20-1 judges existence of additional results (S608). If an addition has been made normally, the communication node 20-1 transmits the participation permit (S604). If the addition has not been made normally, the process returns to Step 605. The communication node 20-1 repeats Steps 605 to 608 until registrations to the authentication DB 210 are completed successfully. At this time, the given certain number of trial runs is set, and, if the number of trial runs thus set is exceeded, the processes will be treated as time out. Note that, here, the method for an on-line registration is described. However, another method is also possible wherein a network administrator will directly communicate with the communication node 20-1 and write information on a terminal.

Referring to FIG. 7, the communication node 20-2 initiates reception of a packet and periodically transmits an RA to all terminals within the domain (S701). Upon receiving a BU (S702), the communication node 20-2 makes an inquiry on an address to the HA 30 (S703). Upon receiving an address of a communication node before making movement from the HA 30 (S704), the communication node 20-2 transmits a DB update request signal to the address concerned (S705) and receives a DB update signal (S706). Thereafter, the communication node 20-2 updates the authentication DB 210 by using terminal information which is contained in the DB update signal (S707).

Upon receiving a participation request from the terminal 10B-m (S708), the communication node 20-2 retrieves the authentication DB 210 (S709). The communication node 20-2 makes a judgment on the retrieval result (S710). If user information exists (YES), the communication node 20-2 transmits a signal to permit participation (S712). If no user information exists (NO), the communication node 20-2 transmits a signal of authentication request (S712). Thereafter, the communication node 20-2 receives a terminal information registration (S713) and add the registration to the authentication DB (S714). Next, the communication node 20-2 makes a judgment on the addition result (S715). If addition is performed correctly, the communication node 20-2 transmits a participation permit (S711). When addition is not performed correctly, the process returns to Step 712 and the communication node 20-2 repeats Steps 712 to 715 until the terminal information registration is completed correctly. Note that, however, the upper limit of the number of repeating times will be set, and if the number of repetitions exceeds the specified number of times, the processes will be treated as time out.

Referring to FIG. 8, the communication node 20-1 which received a DB update request from the communication node 20-2 (S801) generates a DB update signal containing block information which includes differential information stored in its own authentication DB 210 and transmits the signal to the communication node 20-2 (S802).

Hereinafter, flows of BU reception operations of the HA will be described with reference to FIG. 9. When receiving a BU with an inquiry about the address of a before-movement communication node from a communication node (S901 YES), the HA 30 first refers to an address management table (S902). Then, it returns the current transfer destination address to the after-movement communication node (S903), and then updates the transfer table by using CoA in which the BU is contained (S904). On the other hand, When the HA 30 receives a BU without an inquiry about an address (S905), the HA 30 executes only update of the transfer table (S904) by using the CoA containing the BU.

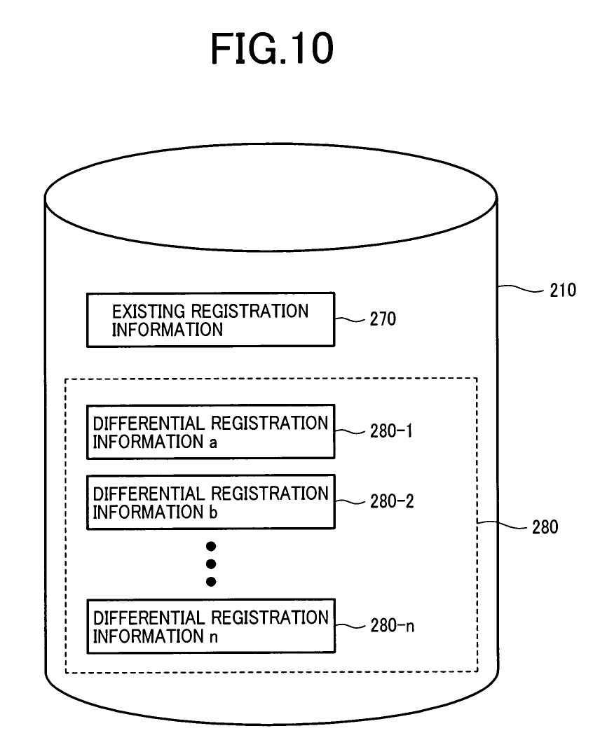

Hereinafter, a logic structure of the authentication DB will be described by using FIG. 10. Here, FIG. 10 is a block diagram for describing a logic structure of the authentication DB. The authentication DB 210 includes existing registration information 270 and block information 280. The block information 280 further includes a plurality of pieces of differential registration information a to n (280-1 to 280-n). For example, each of the communication nodes 20-1 to 20-3 in FIG. 1 includes the authentication DB 210, and the existing registration information 270 is a default value which is common to the entire authentication DBs stated above. The default value will be set by the network administrator to each of the communication nodes individually. Next, when receiving a participation request from a terminal, a communication node compares the request with the existing registration information 270 and judges whether terminal authentication should be made or not. If terminal information is not contained in the existing registration information 270, the communication node extracts registration information from the terminal information registration message and adds the information to the authentication DB 210 as differential registration information a 280-1. Further, when other non-registered terminals participated, the registration information will also be added to the authentication DB 210 as differential registration information b to n (280-2 to 280-n).

It should be noted that an example of terminal registration has been shown here. However, the similar procedures may be employed to add registration information for the case wherein profile information of a user is used. Then, at a point when a DB update request signal is received, a DB update signal is transmitted while the differential registration information a to n (280-1 to 280-n) are put together as the block information 280. In addition, a logic structure of the authentication DB 210 is shown here, but, for actual mounting, the logic unit shall be divided in accordance with the file structure of a hard disk, an optical disk or a semiconductor memory.

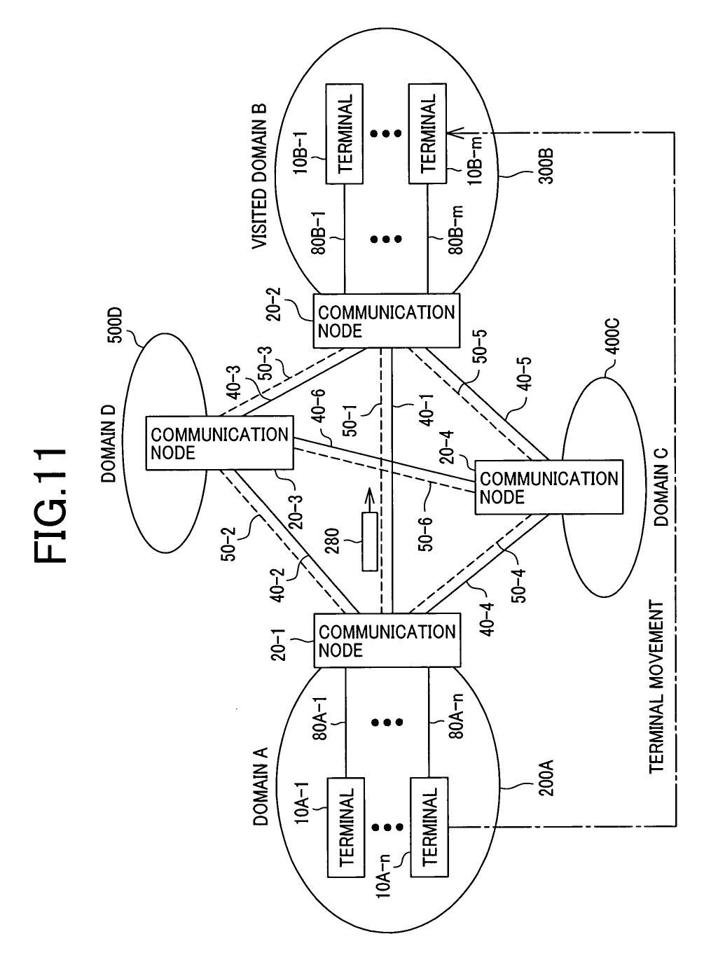

Hereinafter, a method for updating an authentication DB will be described by using FIGS. 11 to 13. Here, FIGS. 11 to 13 are block diagrams of communication network. In addition, FIGS. 11 to 13 illustrate the transfer status of block information to communication nodes at the movement destination of terminals.

Referring to FIG. 11, a first method for updating the authentication DB 210 will be described. In FIG. 11, four communication nodes 20 (20-1 to 20-4) are inter-connected via data channels 40 (40-1 to 40-6) and authentication channels 50 (50-1 to 50-6). When the terminal 10A-n which is in a domain A (200A) containing the communication node 20-1 moves to a domain B (300B) containing the communication node 20-2, the communication node 20-2 transmits a DB update request message to the communication node 20-1. The communication node 20-1 which received the message puts the block information 280 of the authentication DB 210 that belongs to the communication node 20-1 in the DB update message and transmits the message to the authentication DB 210 which belongs to the communication node 20-2.

By updating the authentication DB with such method, it is possible that the terminal 10B-m can initiate communication without registering terminal information anew in the movement-destination domain B (300B).

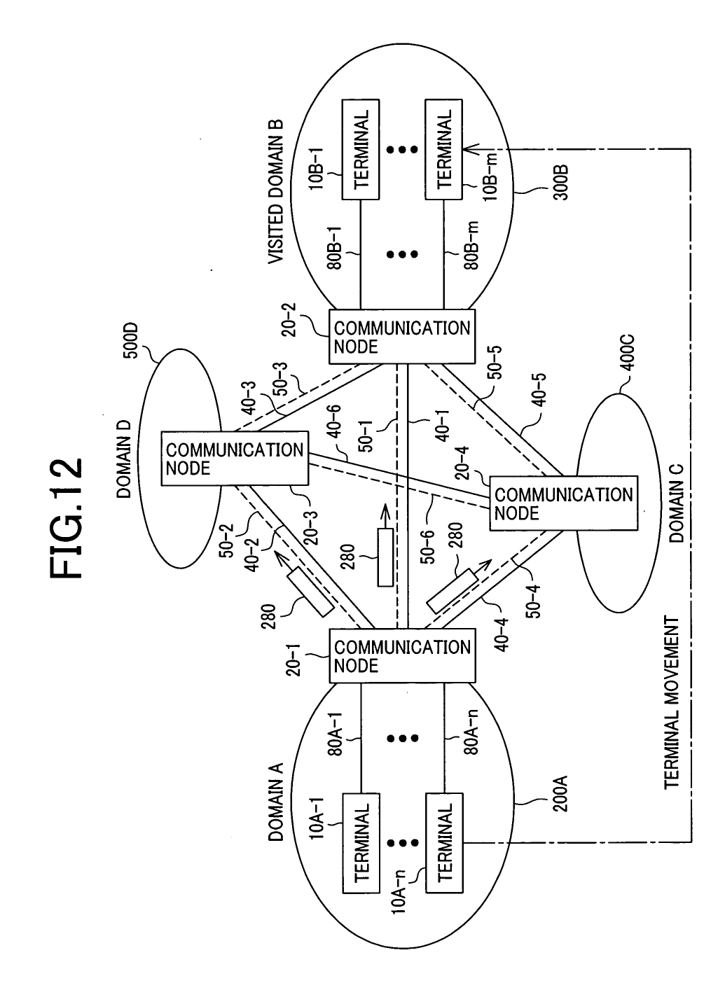

Referring to FIG. 12, a second method for updating the authentication DB 210 will be described. The second method for updating the authentication DB 210 is a method wherein block information is transferred to all communication nodes included in a network. In this example, as is the case with the example shown in FIG. 11, four communication nodes 20 (20-1 to 20-4) are inter-connected via data channels 40 (40-1 to 40-6) and authentication channels 50 (50-1 to 50-6). Now, when a terminal 10A-n in the domain A (200A) containing the communication node 20-1 moves to the domain B (300B) containing the communication node 20-2, the communication node 20-2 transmits a DB update request message to the communication node 20-1. The communication node 20-1 which received the message puts the block information 280 of the authentication DB 210 that belongs to the communication node 20-1 in the DB update message and transmits the message to all communication nodes 20-2, 20-3 and 20-4. In addition, the DB update message can also be transmitted as a broadcast signal.

By adopting such an updating method, it is possible to keep all authentication DBs that are connected to a network under the synchronized status, thus enabling to initiate communication without registering terminal information anew irrespective of terminal movement to any domain.

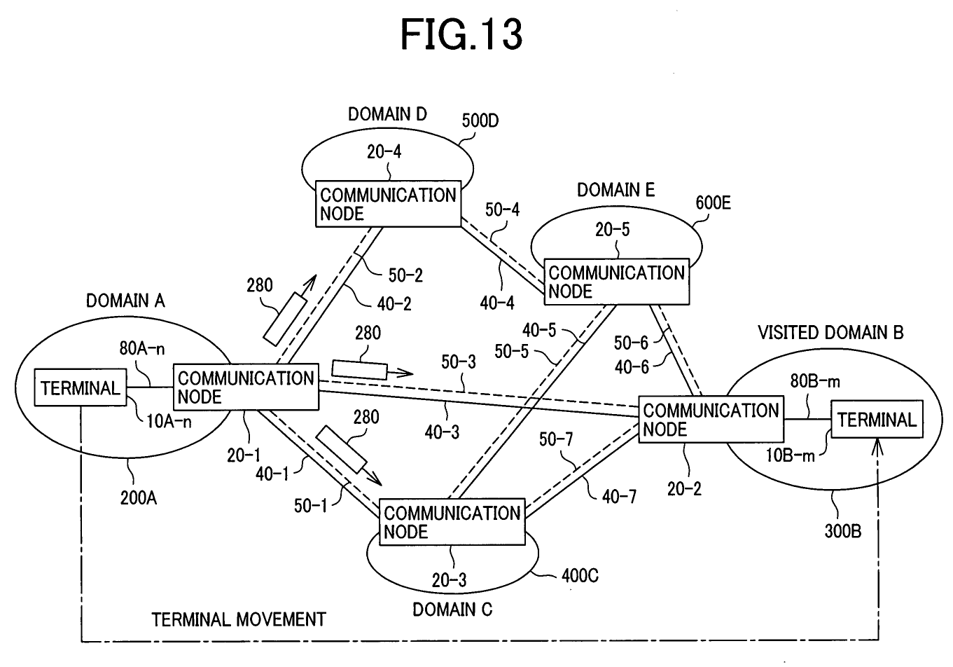

Referring to FIG. 13, a third method for updating the authentication DB 210 will be described. The third method for updating the authentication DB 210 is a method for transferring block information to a communication node which is located in proximity to the communication node at the movement destination of a terminal. Here, five communication nodes 20 (20-1 to 20-5) are connected in meshed status via data channels 40 (40-1 to 40-7) and authentication channels 50 (50-1 to 50-7). Now, when a terminal 10A-n in the domain A (200A) containing the communication node 20-1 moves to the domain B (300B) containing the communication node 20-2, the communication node 20-2 transmits a DB update request message to the communication node 20-1. The communication node 20-1 which received the message puts the block information 280 of the authentication DB 210 that belongs to the communication node 20-1 in the DB update message and transmits the message to the authentication DB 210 which belongs to the communication node 20-2 at the destination of the terminal and to the authentication DB 210 which belongs to the communication nodes 20-3 and 20-4 which are located in proximity to the communication node 20-1 and are directly connected to the communication node 20-1.

In this case, the authentication DB of the communication node 20-5 which is in a domain E and is not directly connected to the communication node 20-1 will not be updated. However, the authentication DB will be updated when a terminal 10 which is in the domain B (300B) containing the communication node 20-2 moves to the domain A (200A) which contains the communication node 20-1.

By updating the authentication DB 210 with such a method, it is possible to reduce the volume of. authentication traffics in a network in comparison with a broadcast system shown in FIG. 12. As a result, it is possible to shorten time that is required for updating the authentication DB.

According to the embodiment, a user who uses a terminal can resume communication without registering terminal information anew in the database at the destination even when conducting handover (movement between domains).

[Embodiment 2]

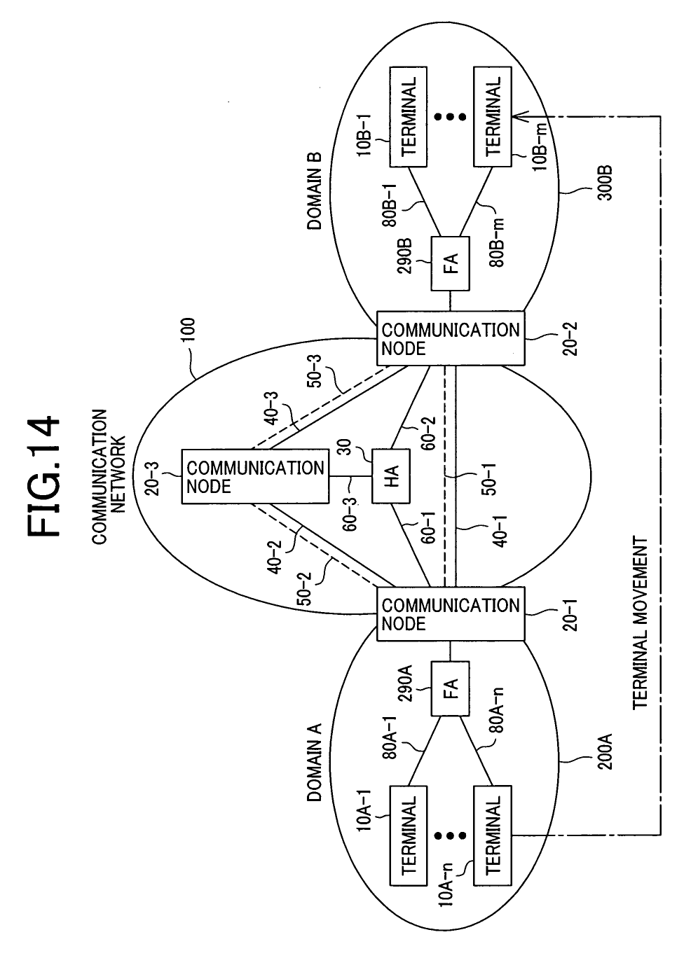

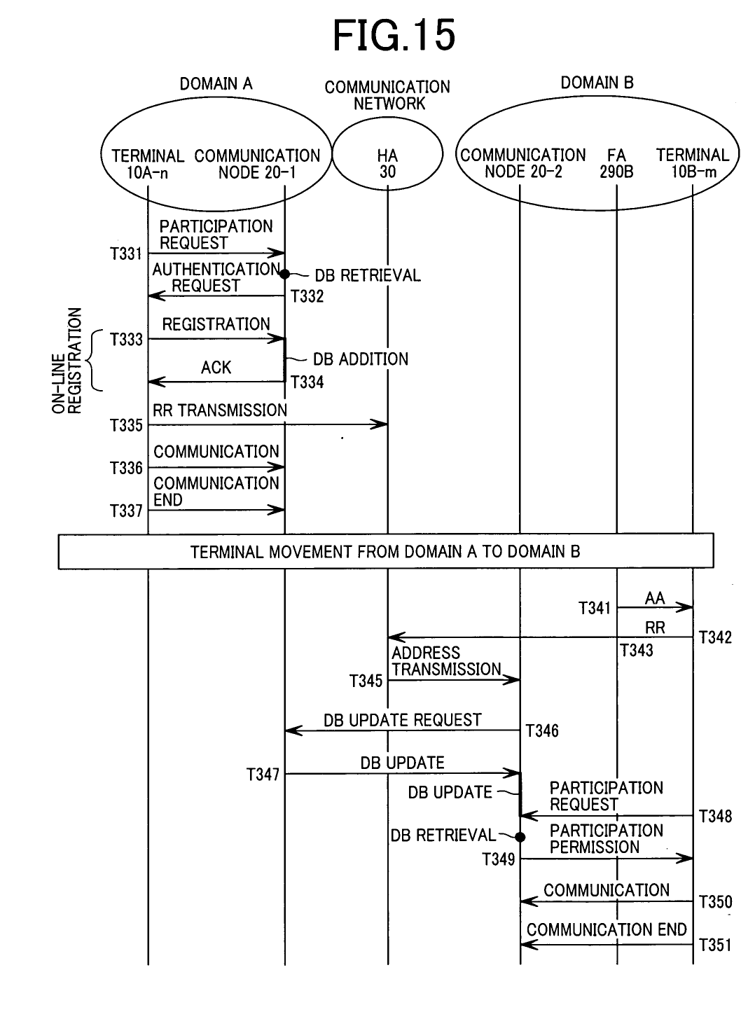

Next, a second embodiment will be described with reference to FIGS. 14 and 15. The second embodiment is an embodiment wherein the mobileIPv4 (version 4) which is standardized by the IETF is applied to the Layer 3 protocols. FIG. 14 is a block diagram which describes a configuration of a network wherein a communication network 100 is connected to domains 200A and 300A. To the communication network 100, communication nodes 20-1, 20-2 and 20-3 as well as an HA 30 belong, and the communication nodes 20-1, 20-2 and 20-3 are connected to HA 30 through communication lines 60-1, 60-2 and 60-3, respectively. Further, the three communication nodes are connected through data channels 40-1, 40-2 and 40-3 which transfer a data signal, and through authentication channels 50-1, 50-2 and 50-3 which transfer a control signal used for synchronization, etc. of an authentication DB (Data Base) that is incorporated in each of the above-stated communication nodes.

An FA (Foreign Agent) 290A and terminals 10 (10A-1 to 10A-n) belongs to the domain 200A and another FA 290B and other terminals 10 (10B-1 to 10B-m) belongs to the domain 300B. Each terminal (10A-1 to 10A-n) is connected to the FA 290A via communication lines 80 (80A-1 to 80A-n) and each terminal (10B-1 to 10B-m) is connected to the FA 290B via communication lines 80 (80B-1 to 80B-m). With the embodiment, a wireless LAN (IEEE802.11) is applied to the communication lines 80.

The communication node 20 which is applied in the embodiment is similar to the communication node shown in FIG. 2. Note that, however, the binding update message monitoring program monitors an RR (Registration Request) message instead of the BU message, which occurs due to a difference between IPv6 and IPv4. Each of the BU message and the RR message is a message to change a transfer destination.

Next, operations of respective apparatuses which configure the communication network shown in FIG. 14 will be described with reference to FIG. 15. FIG. 15 is a transition diagram describing operations of respective apparatuses configuring the communication network. The terminal 10A-n in the domain A transmits a participation request to the communication node 20-1 (S331). Upon receiving the participation request, the communication node 20-1 retrieves the authentication DB 210. If confirming that the terminal 10A-n is not registered, the communication node 20-1 returns an authentication request to the terminal 10A-n (T332). In response to this, the terminal 10A-n transmits a registration message to the communication node 20-1 (T333). Upon receiving the message, the communication node 20-1 writes the registration content in the. authentication DB 210. Next, the communication node 20-1 transmits an ACK (Acknowledge) message to the terminal 10A-n (T334). This completes the on-line registration.

Upon receiving the ACK, the terminal 10A-n transmits a RR (Registration Request) message containing the addresses of the terminal 10A-n and the communication node 20-1 to the HA 30 (T335). Upon receiving the RR message, the HA 30 writes the addresses of the terminal 10A-n and the communication node 20-1 in an address management table. Thereafter, the terminal 10A-n transmits a communication message to the communication node 20-1 (T336) to initiate communication with a server or the like.

After a while, the terminal 10A-n moves from the domain A to the domain B. Before the movement, the terminal 10A-n transmits a communication end message to the communication node 20-1 (T337). At the destination, the terminal 10B-m (before-movement terminal 10A-n) receives an AA (Agent Advertisement) from an FA 290B (T341). Since the prefix of AA is different form the prefix of its own, the terminal 10B-m generates CoA (Care of Address) and transmits an RR (Registration Request) message containing the CoA to the FA 290B (T342). The FA 290B transfers the message to the HA 30 (T343). Upon receiving the message, the HA 30 retrieves the address control table for the address of the before-movement communication node 20-1, and transmits a registration response message to which the address thus found is added to the communication node 20-2 (T345).

The communication node 20-2 in the domain B transmits a DB update request message to the communication node 20-1 in the domain A which was the before-movement domain of the terminal 10B-m (T346). Being triggered by the reception of the message, the communication node 20-1 transmits a DB update message containing new registration content in the authentication DB 210 to the communication node 20-2 (T347). Upon receiving the message, the communication node 20-2 updates content of the authentication DB 210 of its own.

Thereafter, the terminal 10B-m transmits a participation request to the communication node 20-2 (T348). Since the communication node 20-2 has already updated the content of the authentication DB 210 and owns data on the terminal 10B-m (terminal 10A-n) which is already on-line registered in the authentication DB 210 in the domain A, the communication node 20-2 transmits a participation permit to the terminal 10B-m (T349). In response to this, the terminal 10B-m transmits a communication message signal and resumes communication with the server (T350).

According to the embodiment, a user who uses a terminal can resume communication without registering terminal information anew in the database at the destination even when conducting handover (movement between domains).

[Third Embodiment]

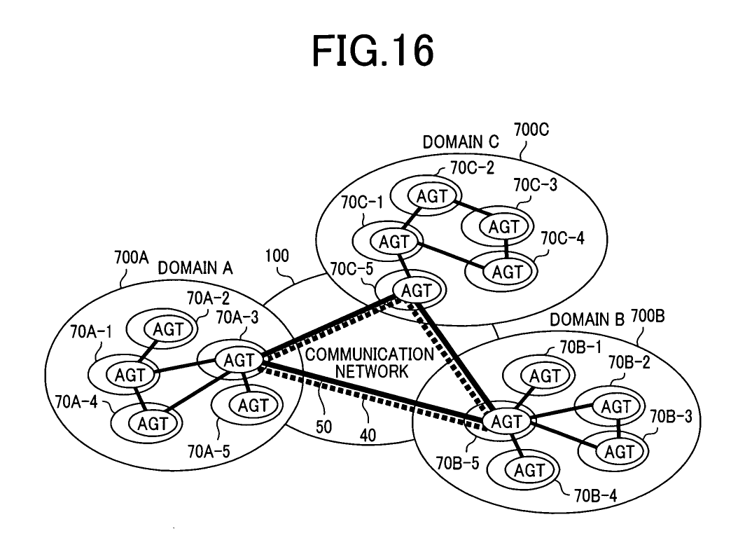

Next, a third embodiment will be described with reference to FIGS. 16 to 22. FIG. 16 is a diagram illustrating an example of network configuration of the third embodiment.

Referring to FIG. 16, a domain A (700A), a domain B (700B) and a domain C (700C) are connected with each other via a communication network 100. Hereinafter, the domains A (700A) to C (700C) will be generically referred to as a domain 700.

The domain 700 is an administrative unit of a network. For example, an ISP (Internet Service Provider) is a local unit for administrating a network. The domain 700 includes a communication node (AGT) which executes authentication processing according to an authentication request. Further, the domain 700 includes a zone 70 which is an area in which an AGT 80 is connectable to the terminal 100. For example, the domain A (700A) includes zones 70A-1 to 70A-5. These zones 70A-1 to 70C-5 will be generically referred to as the zone 70. At least one AGT among the domain 700 is connected with at least one AGT of another domain 700 via an authentication channel 50 and a data channel 40. The authentication channel 50 exchanges authentication data mainly for executing authentication of a terminal. The data channel 40 exchanges a packet from a terminal not shown.

The AGT 80 of a zone 70A-3 included in the domain A (700A), the AGT 80 of the zone 70A-5 included in the domain B (700B) and the AGT 80 of the zone 70C-5 included in the domain C (700C) are connected with each other with the authentication channel 50 and the data channel 40 via the communication network 100. The AGT 80 includes a HUB-type AGT and an associated AGT. The HUB-type AGT is an agent that is connected in a loop formed with unicursal polygons. The associated AGT is an agent that is not connected in a loop. Since the associated AGT is connected to a HUB-type AGT that is located nearest thereto, the packet transfer time between the HUB-type AGT and the associated AGT can be minimized.

For example, in the domain A (700A), the AGT 80 of the zone 70A-1, the AGT 80 of the zone 70A-3 and the AGT 80 of the zone 70A-4 are of the HUB-type AGTs, and the AGT 80 of the zone 70A-2 and the AGT 80 of the zone 70A-5 are of the associated AGT. The AGT 80 of the zone 70A-2 and the AGT 80 of the zone 70A-5 are each connected to the HUB-type AGT located nearest thereto. That is, the AGT 80 of the zone 70A-2 and the AGT 80 of the zone 70A-5 are connected to the AGT 80 of the zone 70A-1 and the AGT 80 of the zone 70A-3, respectively.

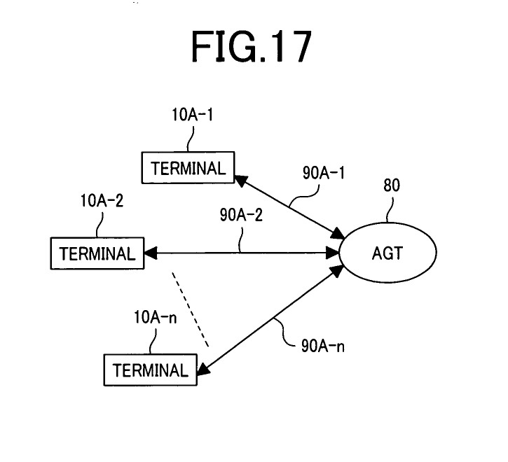

FIG. 17 is a diagram illustrating a configuration of the zone 70 of the third embodiment. The zone includes an AGT 80 and terminals 10 (a terminal 10A-1 to a terminal 10A-n). The AGT 80 and the terminals 10A-1 to 10A-n are connected via respective links 90A-1 to 90A-n using a wireless LAN. It should be noted that the terminals 10 is a generic name for terminals 10A-1 to 10A-n connected to the AGT 80, and the links 90 is a generic name for links 90A-1 to 90A-n.

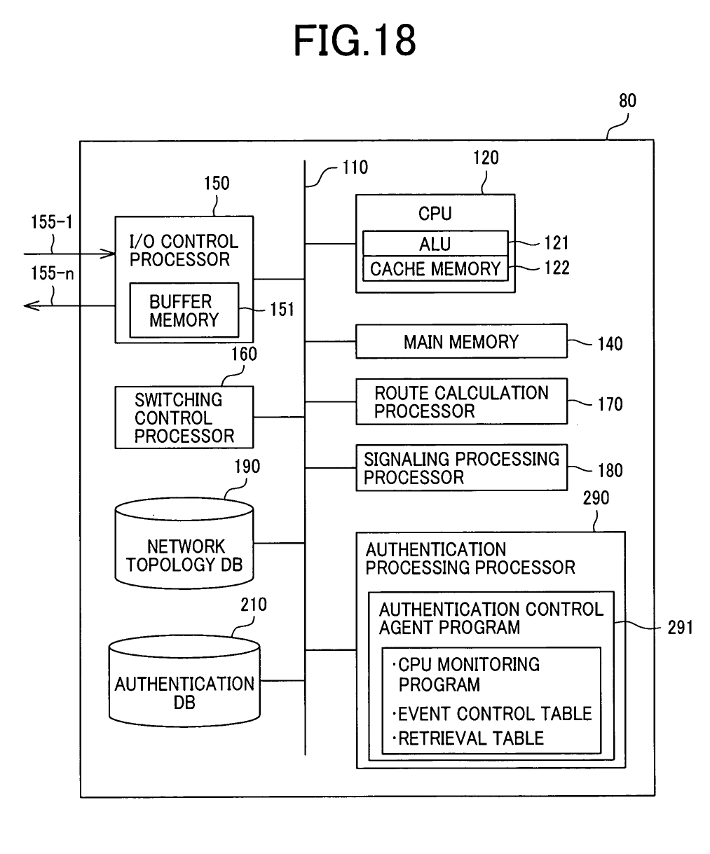

FIG. 18 is a block diagram illustrating a configuration of an AGT 80. The AGT 80 includes a bus 110, an I/O control processor 150, a CPU 120, a switching control processor 160, a main memory 140, a network topology DB 190, a route calculation processor 170, a signaling processing processor 180, an authentication DB 210 and an authentication processing processor 290.

The I/O control processor 150, the CPU 120, the switching control processor 160, the main memory 140, the network topology DB 190, the route calculation processor 170, the signaling processing processor 180, the authentication DB 210 and the authentication processing processor 290 are connected with each other via the bus 110. The I/O control processor 150 is a processor that controls communication trough I/O lines 155-1 to 155-n. For example, the I/O lines include the links 90, etc. which connect AGTs 80, or connect terminals 10 and the AGT 80. It should be noted that the I/O output control processor 150 includes a buffer memory 151 which temporarily stores packets to be input or output by the I/O control lines 155-1 to 155-n. The CPU 120 includes an arithmetic and logic unit (ALU) 121 and a cache memory 122. The ALU 121 is a circuit that executes four-function calculations, logical operations, etc. The cache memory 122 is a storage area in which data frequently used by the CPU 120 is stored. The CPU 120 executes various programs to process authentication, etc.

The switching control processor 160 controls a switch fabric, not shown, to switch the I/O port from the I/O output lines 155-1 to 155-n. The main memory 140 is a storage area in which various programs to be executed by the CPU 120 are stored. The network topology DB 190 stores topologies of the AGTs 80 in the domain 700. The route calculation processor 170 is a processor that calculates a route for connecting the AGTs 80 in the domain 700. The signaling processing processor 180 sets out a logical path on the route calculated by the route calculation processor 170.

The authentication DB 210 stores authentication data that is required for authentication of the terminal 10. The authentication processing-processor 290 includes an arithmetic processing module which executes programs and a memory 291 that stores programs to be executed by the arithmetic processing module. In the memory 291, an authentication control agent program is stored. In addition, the authentication control agent program includes a CPU monitoring program and an event control program.

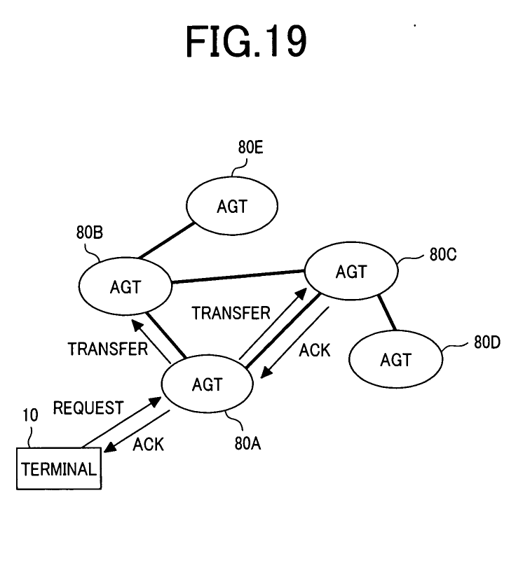

FIG. 19 is a diagram illustrating flows of a request packet and an ACK packet. The terminal 10 transmits a request packet which is an authentication request to an AGT 80A to which the terminal 10 is connected for participating in the network. The AGT 80A, upon receiving the request packet, transfers the request packet to an AGT 80B and an AGT 80C which are directly connected to the AGT 80A when the AGT 80A judges that the CPU 120 of the AGT 80A is in the high-load status. The AGT 80B and the AGT 80C, upon receiving the request packet, judge the status of the CPU 120 included in each AGT.

The AGT 80C, when judging that the CPU 120 of the AGT 80C is in the low-load status, executes authentication processing of the terminal 10 and transmits an ACK packet to the AGT 80A. On the other hand, the AGT 80B, when judging that the CPU 120 of the AGT 80B is in the high-load status, does not execute authentication processing. The AGT 80A, upon receiving an ACK packet from the AGT 80C, transfers the ACK packet to the terminal 10.

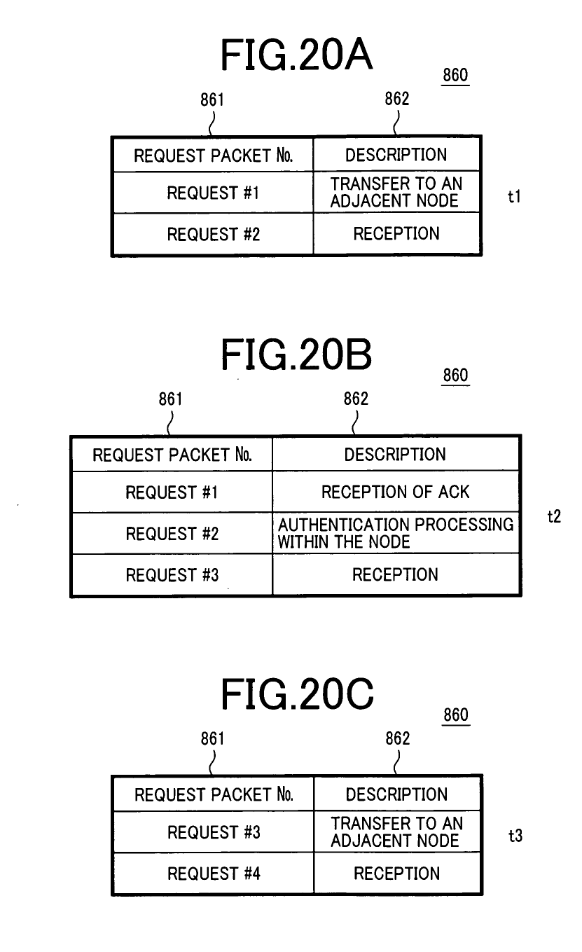

FIGS. 20A to 20C are schematic diagrams illustrating event control tables of the AGTs 80. Each AGT 80 has an event control table 860 which controls processing by the AGT 80. The event control table 860 includes a request packet No. 861 and description 862. The request packet No. 861 is a unique identifier of a request packet. The description 862 shows processing that has been executed on a request packet. The request packet No. 861 and the description 862 which are included in the event control table 860 will be subjected to change according to processing executed by the AGT 80 on a request packet.

For example, the event control table 860 illustrated in FIG. 20A shows description of items to be controlled by the AGT 80A at time t1. More specifically, transfer of a request packet received to an adjacent node (request #1) and reception of a request packet from the terminal 10 (request #2) are held. The event control table 860 illustrated in FIG. 20B shows description of items to be controlled by the AGT 80A at time t2. More specifically, the request packet transferred at time t1 is subjected to authentication processing in another AGT, and it is held that the AGT 80A receives an ACK packet which is a result of the authentication processing (request #1), executes authentication processing within the AGT of a request packet received at time t1 (request #2), and receives a new request packet (request #3). The event control table 860 illustrated in FIG. 20C shows description of items to be controlled by the AGT 80A at time t3. More specifically, transfer of a request packet received at time t2 to an adjacent node (request #3) and reception of a new request packet by the AGT 80A (request #4) are held. It should be noted that authentication processing of the request #1 and the request #2 has been completed at time t2, and the event control table 860 at time t3 does not hold the request #1 and the request #2.

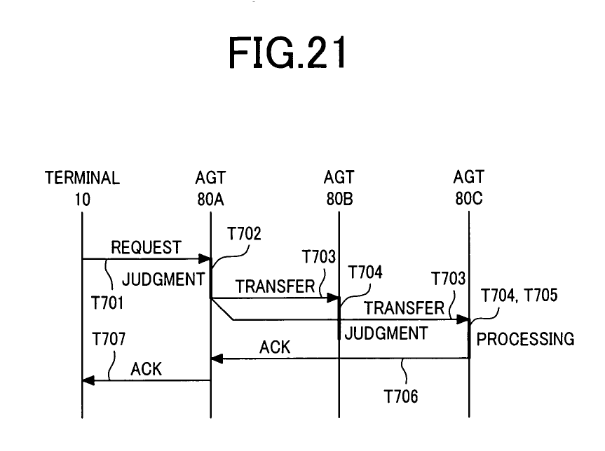

FIG. 21 is a sequence diagram illustrating operations of a terminal 10 and AGTs 80. The terminal 10 transmits a request packet to AGTs 80 (T701).

The AGT 80A, upon receiving a request packet, judges a load on the CPU 120 included in the AGT 80A (T702). In the processing for judging the CPU load, a judgment is made as to whether the load on the CPU of each AGT 80 is larger or not than the prescribed threshold. As a result, if the load on the CPU 120 is larger than the threshold, the load is judged to be high. If the load on the CPU 120 is smaller than the threshold, the load is judged to be low. Here, it shall be supposed that the AGT 80A makes judgment that the load on the CPU 120 is high. At this time, since it takes time when the AGT 80A executes the authentication processing, which deteriorates the throughput of the network, the AGT 80A tries to make another AGT to carry out the authentication processing for the AGT 80A. Thereafter, the AGT 80A transfers the request packet to the AGT 80B and the AGT 80C which are directly connected to the AGT 80A (T703).

The AGT 80B, upon receiving the transferred request packet, executes judgment 704. The AGT 80B judges that the load on the CPU 120 included in the AGT 80B is high and does not execute authentication processing. On the other hand, the AGT 80C, upon receiving a transferred request packet 703, executes judgment processing (T704). The AGT 80C judges that the load on CPU 120 included in the AGT 80C is low and execute authentication processing (T705). The AGT 80C, upon completing the authentication processing, transmits an ACK packet which includes an authentication result to the AGT 80A (T706). The AGT 80A, upon receiving the ACK packet, transfers the ACK packet to the terminal 10 (T707).

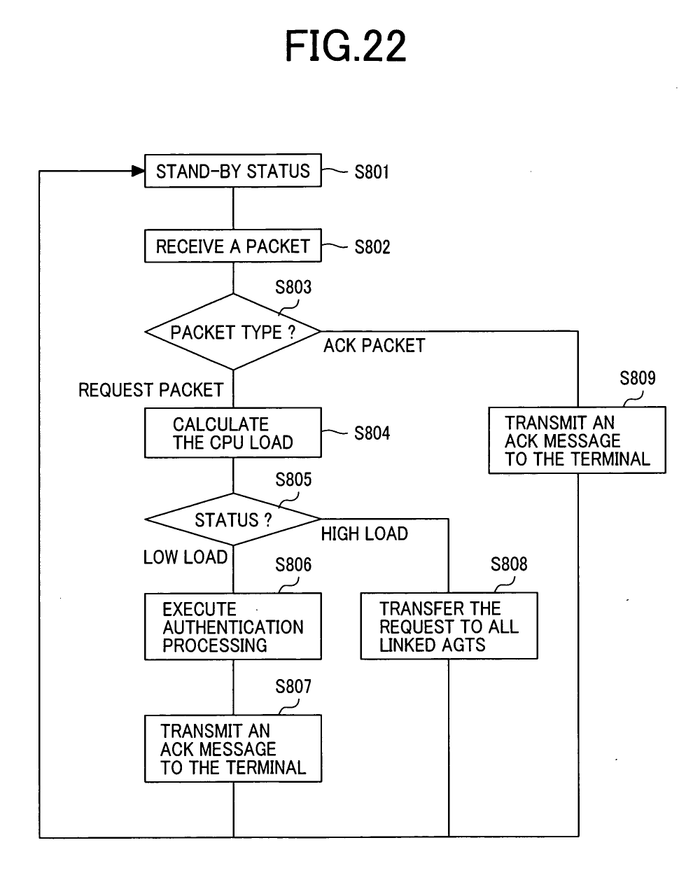

FIG. 22 is a flow chart of an authentication agent program to be executed in the AGT 80 referred to in the third embodiment. The AGT 80 is in a stand-by status which is ready for receiving a packet (S801). The AGT 80, upon receiving a packet in a stand-by status, (S802), judges whether the received packet is a request packet or an ACK packet (S803). When the packet that the AGT 80 received is an ACK packet, the AGT 80 transmits the ACK packet to the terminal 10 which transmitted a request packet (S809) and returns to a stand-by status (S801).

On the other hand, when the packet that the AGT 80 received is a request packet, the AGT 80 calculates load (the usage rate of the CPU) of the CPU 120 included in the AGT 80 (S804), and judges the load status of the CPU 120 (S805). For example, the AGT 80 judges the load is high when the occupancy rate of the CPU 120 is 80% or over, or alternatively, the AGT 80 can judge that the load is low when load on the CPU 120 is less than 80%.

The AGT 80, when judging that the CPU 120 is in a high-load status, transfers the request packet to all linked AGTs 80 connected directly to the current AGT 80 (S808) and returns to a stand-by status (S801). On the other hand, the AGT 80, when judging that the CPU 120 is in a low-load status, executes authentication processing (S806), transmits the ACK packet to the terminal which transmitted the request packet (S807) and returns to a stand-by status (S801).

With the third embodiment, as described above, the AGT 80A and the AGT 80B whose CPU 120 are in a high-load status do not execute authentication processing of the terminal 10, and, instead, the AGT 80C whose CPU 120 is in a low-load status executes authentication processing of the terminal 10. Therefore, it is possible to prevent deterioration in the access processing capability (access throughput) of the entire network without allowing time required for authentication processing to increase. It should be noted that, in Step 808, the request packet may be transferred to all AGTs 80 in the domain 700.

[Fourth Embodiment]

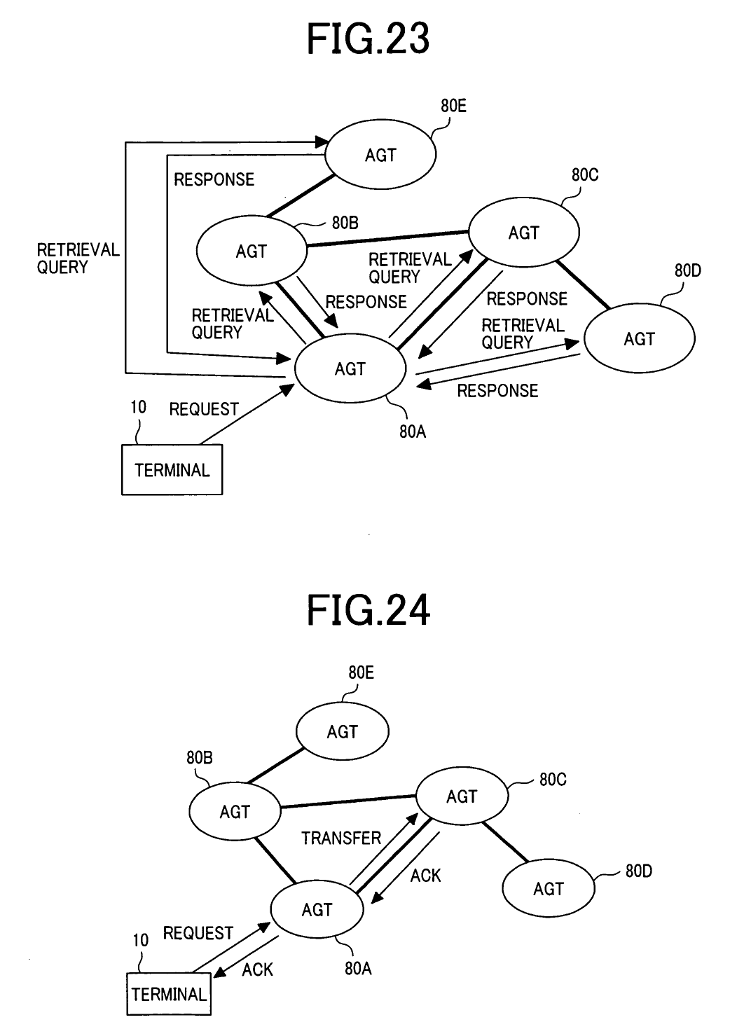

A fourth embodiment will be described with reference to FIGS. 23 to 27. In the fourth embodiment, the AGT 80A which received a request packet from the terminal 10 transmits a retrieval query to the AGT 80A and all AGTs 80 in a domain 700 if the CPU 120 included in the AGT 80A is in a high-load status. Then, the AGT 80A identifies an AGT 80 that is suitable for processing the request packet and transfers the request packet to the AGT 80 thus identified. It should be noted that, for the same configuration as that referred to for the third embodiment, the same reference numerals will be given to the same configurations, and redundant descriptions thereof will be omitted.

First, flows of packets of the embodiment will be described. FIG. 23 is a diagram illustrating flows of a retrieval query and a response packet, and FIG. 24 is a diagram illustrating transfer of a request packet and flows of an ACK packet.

The AGT 80A, upon receiving a request packet from the terminal 10, transmits a retrieval query to the AGTs 80B to 80E if the CPU 120 included in the AGT 80A is in a high-load status. Each of the AGTs 80B to 80E, upon receiving the retrieval query, transmits a response packet to the AGT 80A.

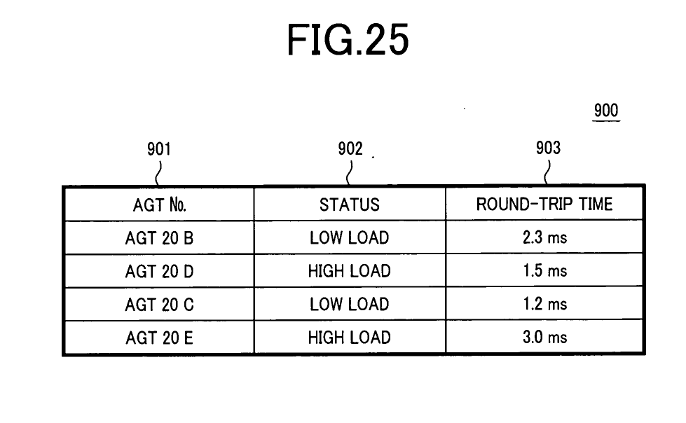

Next, referring to FIG. 24, the AGT 80A, upon receiving a response packet from the AGTs 80B to 80E, creates a retrieval table, which will be described later, (see FIG. 25), identifies an AGT 80 that is suitable for processing the request packet, and transfers the packet to the AGT 80C thus identified. The AGT 80C, upon receiving the request packet, executes authentication processing. Then, the AGT 80C, after completing the authentication processing, transmits an ACK packet which includes an authentication result to the AGT 80A. The AGT 80A, upon receiving the ACK packet, transmits the ACK packet to the terminal 10.

FIG. 25 is a schematic diagram illustrating a retrieval table 900. The retrieval table 900 is stored in a memory in the authentication processing processor 290 included in the AGT 80. The retrieval table 900 includes an AGT number 901, a status 902 and round-trip time 903.

The AGT number 901 is a unique identifier of an AGT 80 which is in the same domain as the AGT 80A. The status 902 shows loading status of the CPU 120 included in the AGT 80. More specifically, the status 902 shows whether the CPU 120 is in a low-load status or in a high-load status. The round-trip time (RTT) 903 shows time from a point when the AGT 80A transmits a retrieval query to each of the AGTs 80B to 80E to a point when the AGT 80A receives a response packet from each of the AGTs 80B to 80E.

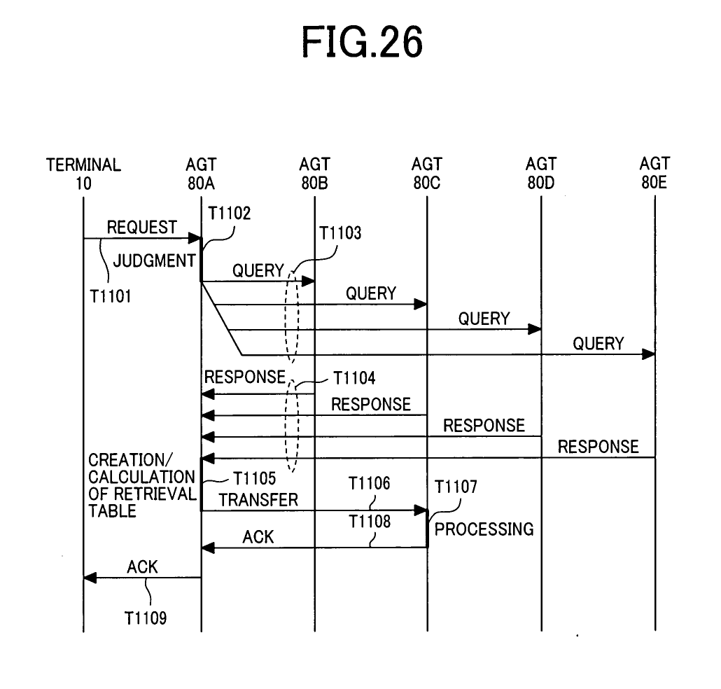

FIG. 26 is a sequence diagram illustrating operations of a terminal 10 and AGTs 80 of the embodiment. The terminal 10 transmits a request packet to the AGT 80A (T1101). The AGT 80A, upon receiving the request packet, judges the load of the CPU 120 included in the AGT 80A (T1102). Here, it shall be supposed that the AGT 80A judges the CPU 120 is in a high-load status. At this time, since it takes time when the AGT 80A executes authentication processing, which deteriorates the throughput of the network, the AGT 80A tries to cause another AGT to carry out the authentication processing for the AGT 80A. Then, the AGT 80A transmits the retrieval query to all AGTs (AGT 80B, AGT 80C, AGT 80D and AGT 80E) which are in a same domain (T1103).

Each of the AGTs 80B to 80E, upon receiving the retrieval query, acquires the occupancy rate of the CPU 120 which is included in each of the AGTs. Then, each of the AGTs 80B to 80E transmits a response packet which includes identifiers for identifying the AGTs and information on the occupancy rate of the CPU 120 of each AGT to the AGT 80A (T1104).

The AGT 80A, upon receiving the response packet from each of the AGTs 80B to 80E, creates the retrieval table 900 based on the response packet. More specifically, the AGT 80A judges whether the CPU 120 included in each AGT is in a high-load status or in a low-load status based on information on the occupancy rate of the CPU 120 contained in the response packet and writes the status of the CPU 120 thus judged in the field of the status 902 of the retrieval table. In addition, the AGT 80A also writes time from a point when transmitting a query to receiving the response packet in the field of the round-trip time 903 of the retrieval table 900.

Next, the AGT 80A selects an AGT 80 that is suitable for executing authentication processing by referring to the retrieval table (T1105). In a status illustrated in FIG. 25, since the load on the CPU included in the AGT 80C is low and the round-trip time is shortest, the AGT 80C is chosen for the AGT 80 that is suitable for executing the authentication processing. The AGT 80A transfers the request packet to the AGT 80C thus chosen (T1106).

The AGT 80C that received the request packet executes authentication processing (T1107). The AGT 80C, upon completing authentication processing, transmits an ACK packet which contains an authentication result to the AGT 80A (T1108). The AGT 80A, upon receiving the ACK packet, transfers the ACK packet to the terminal 10 (T1109).

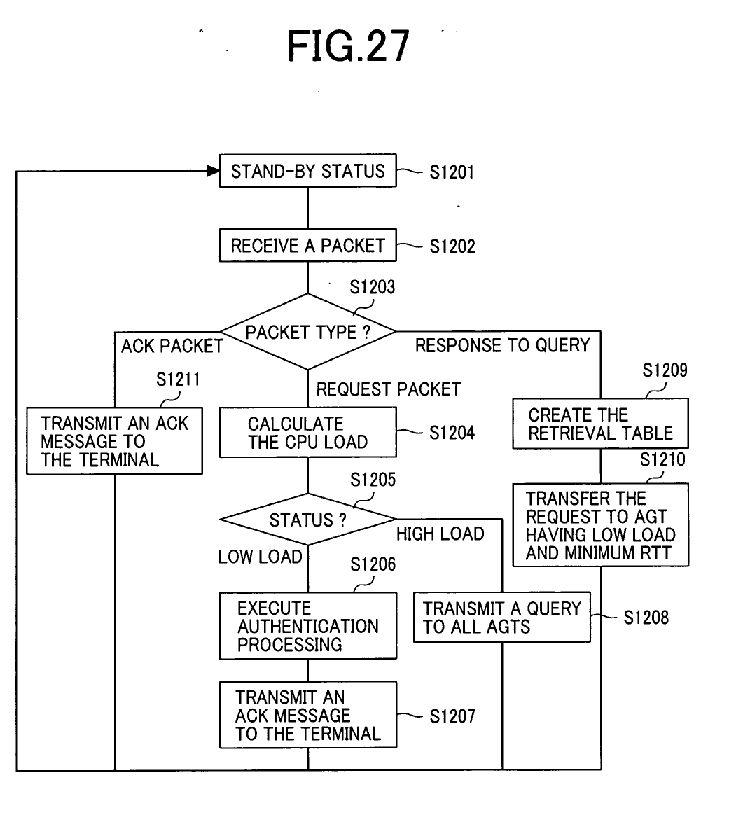

FIG. 27 is a flow chart of an authentication agent program to be executed by the AGT 80. The AGT 80 is in a stand-by status ready for receiving a packet (S1201). The AGT 80, upon receiving a packet (S1202), judges whether the received packet is an ACK packet, a request packet or a response packet to a query (S1203).

When the packet received by the AGT 80 is an ACK packet, the AGT 80 transmits the ACK packet to a terminal that transmitted a request packet (S1211) and returns to the stand-by status (S1201). On the other hand, when the packet received by the AGT 80 is a request packet, the process goes to Step 1204. In addition, when the packet received by the AGT 80 is a response packet to a query, the process goes to Step 1209. In Step 1203, when the packet received by the AGT 80 is a request packet, the AGT 80 calculates load. (an occupancy rate of the CPU) on the CPU 120 included in the AGT 80 (S1204).

Then, the AGT 80 judges the load status of the CPU 120 (S1205). For example, as with the third embodiment stated earlier, the AGT 80 can judge that the CPU 120 is in a high-load status if the occupancy rate of the CPU 120 is 80% or over, and that the CPU 120 is in a low-load status if the load on the CPU 120 is less than 80%. The AGT 80, when judging that the CPU.120 is in a high-load status, transmits a retrieval query to all AGTs in the domain (S1208) and returns to the stand-by status (S1201).

On the other hand, the AGT 80, when judging that the CPU 120 is in a low-load status, executes authentication processing (S1206), transmits an ACK packet to the terminal that transmitted a request packet (S1207) and returns to the stand-by status (S1201). In Step 1203, when the packet received by the AGT 80 is a response packet to a retrieval query, the AGT 80 creates the retrieval table 900 based on the response packet (S1209).

Thereafter, the AGT 80, by referring to the status 902 of the retrieval table 900, chooses an AGT wherein the CPU 120 is in a low-load status and the round-trip time is shortest. In a status illustrated in FIG. 25, the AGT 80C is chosen for the AGT suitable for executing the authentication processing. Then, the AGT 80 transfers the request packet to the chosen AGT (S1210) and returns to the stand-by status (S1201).

With the fourth embodiment, as described above, since an AGT having low load and the shortest round-trip time is chosen as the terminal that executes authentication processing, it is possible to make the authentication time shortest by transferring the request packet to the chosen AGT and executing authentication processing at the transfer destination. As a result, it is possible to prevent deterioration in the access processing capability (access throughput) of the entire network.

[Fifth Embodiment]

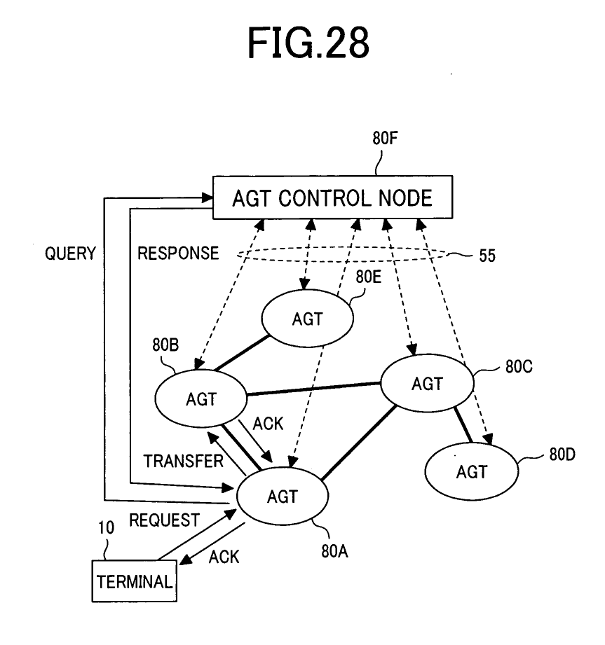

A fifth embodiment will be described with reference to FIGS. 28 to 33. In this the embodiment, upon receiving a request packet from a terminal, an AGT 80 transfers the request packet to another AGT 80 that is chosen by an AGT control node 80F as an AGT suitable for processing the request packet. It should be noted that, the same configurations as those referred to in the third embodiment are given the same reference numerals, and redundant descriptions thereof will be omitted.

FIG. 28 is a diagram illustrating flows of a query packet and a response packet of the fifth embodiment. All AGTs 80A to 80E in a domain 700 are logically connected to the AGT control node 80F which is one of the AGTs 80 via a dedicated line 55. The dedicated line 55 may be either of a fixed line or a wireless line. The AGT control node 80F includes a CPU control table which contains information on the status of CPUs 120 of all ATGs 80 (AGT 80A to AGT 80E) in the domain.

Upon receiving the request packet from the terminal 10, the AGT 80A, if the load status of the CPU 120 included in the AGT 80A is high, transmits a query packet to the AGT control node 80F. The AGT control node 80F chooses the AGT 80B that is suitable for executing authentication processing and transmits a response containing information adapted to identify the chosen AGT 80B to the AGT 80A. The AGT 80A transfers the request packet to the chosen AGT 80B based on the response transmitted from the AGT control node 80F. The AGT 80B, upon receiving the request packet, transmits an ACK packet containing an authentication result to the AGT 80A after the authentication processing is completed. The AGT 80A, upon receiving the ACK packet, transmits the ACK packet to the terminal 10.

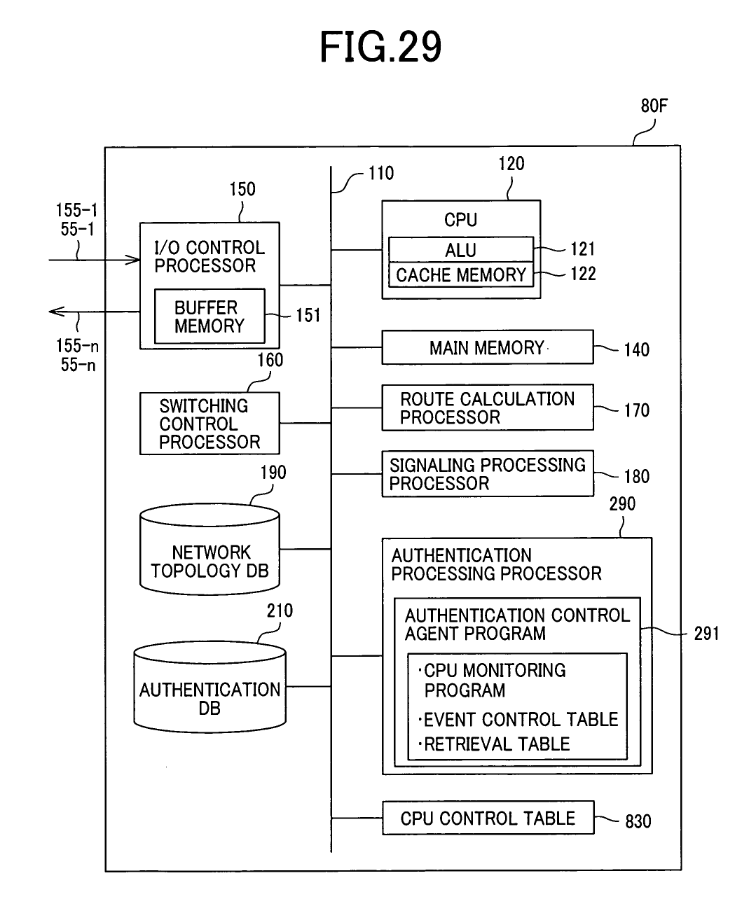

FIG. 29 is a block diagram illustrating a configuration of the AGT control node 80F. The AGT control node 80F is configured in the same way as the AGT 80 (FIG. 18) except that it includes a CPU control table 830. It should be noted that the I/O control processor 150 is a processor that controls communication that is made via I/O output lines 155-1 to 115-n and dedicated lines 55-1 to 55-n.

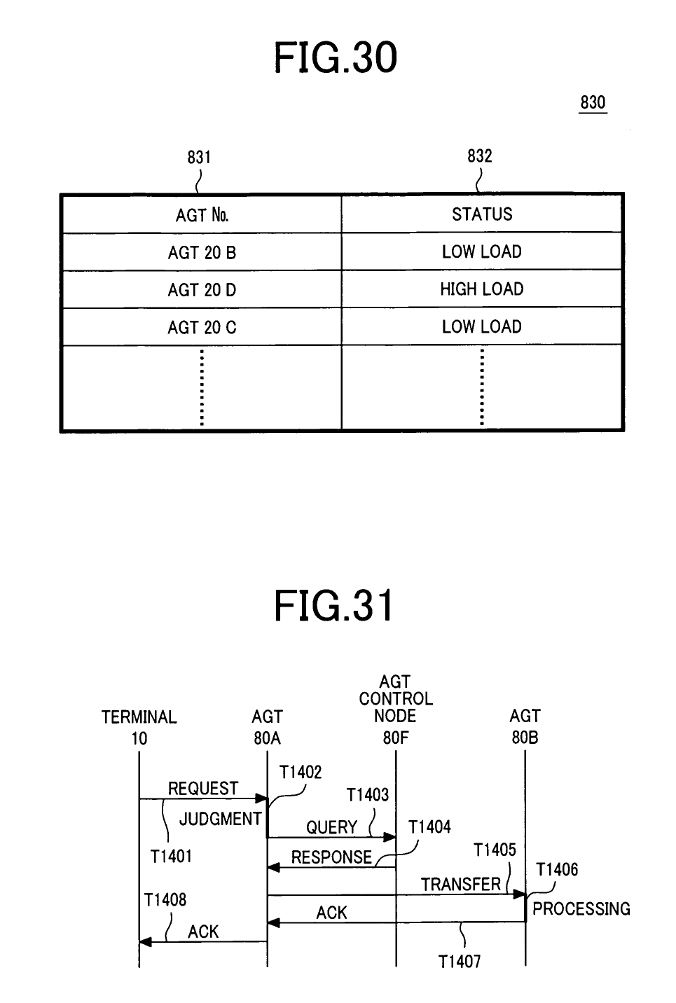

FIG. 30 is a schematic diagram illustrating the CPU control table 830 of the embodiment. The CPU control table 830 includes an AGT number 831 and a status 832. The AGT number 831 is an identifier unique to the AGT 80. The status 832 shows the state of load on the CPU 120 included in the AGT 80. More specifically, the status 832 shows whether the CPU 120 is in a low-load status or in a high-load status. The AGT control node 80F, upon receiving a notification on the status of the CPU included in each of the AGTs 80 via an update packet from each of the AGTs 80, updates the CPU control table 830.

FIG. 31 is a sequence diagram illustrating operations of the terminal 10, the AGTs 80 and the AGT control node 80F. The terminal 10 transmits a request packet to the AGT 80A (T1401). The AGT 80A, upon receiving the request packet, judges load on the CPU 120 included in the AGT 80A (T1402). Here, it shall be supposed that the AGT 80A judges that the CPU 120 is in a high-load status. At this time, since it takes time when the AGT 80A executes authentication processing, which deteriorates the throughput of the network, the AGT 80A tries to cause another AGT to carry out the authentication processing for the AGT 80A. Thereafter, the AGT 80A transmits a query packet to the AGT control node 80F (T1403). The query packet is a packet that requests the AGT control node 80F to choose an AGT that is suitable for executing authentication processing.

The AGT control node 80F, upon receiving the query packet, retrieves the CPU control table 830 for the status 832 and chooses an AGT whose CPU 120 is in a low-load status. At this time, if CPUs 120 of a plurality of AGTs 80 are in a low-load status, the AGT control node 80F will choose an AGT that is positioned at the top of the CPU control table 830. With the status illustrated in FIG. 30, the AGT 80B will be chosen as an AGT that is suitable for executing authentication processing. The AGT control node 80F transmits a response packet containing an identifier of the AGT thus chosen to the AGT 80A (T1404).

The AGT 80A, upon receiving the response packet, transfers the request packet to the AGT 80B which is chosen by the AGT control node 80F (T1405). The AGT 80B, upon receiving the request packet, carries out authentication processing for the AGT 80A (T1406) and transmits an ACK packet containing an authentication result to the AGT 80A (T1407). The AGT 80A, upon receiving the ACK packet, transfers the ACK packet to the terminal 10 (T1408).

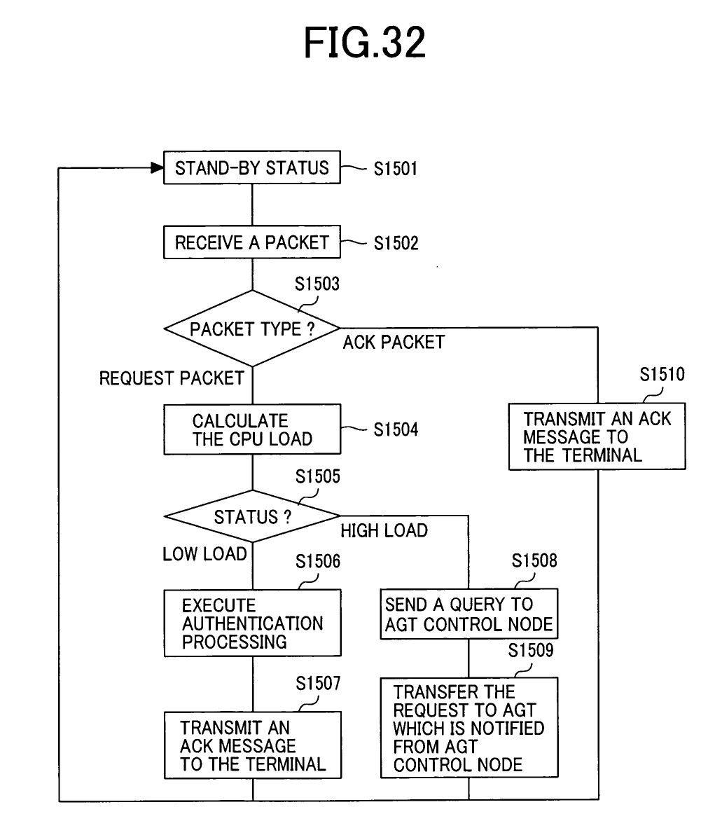

FIG. 32 is a flow chart of an authentication agent program of the AGT 80A. Processing of Steps 1501 to 1505 and Step 1510 of the authentication agent program is the same as that of Steps 801 to 805 and Step 809 of the authentication agent program (FIG. 22) of the third embodiment stated earlier. In Step 1505, the AGT 80A, if judging that the CPU 120 is in a low-load status, executes authentication processing (S1506) and transmits an ACK packet to the terminal 10 that transmitted the request packet (S1507).

On the other hand, in Step 1505, the AGT 80A, if judging that the CPU 120 is in a high-load status, transmits a query packet to the AGT control node 80F (S1508). Thereafter, the AGT 80A, upon receiving a response packet from the AGT control node 80F, transfers the request packet to the AGT chosen by the AGT control node 80F (S1509) and returns to the stand-by status (S1501).

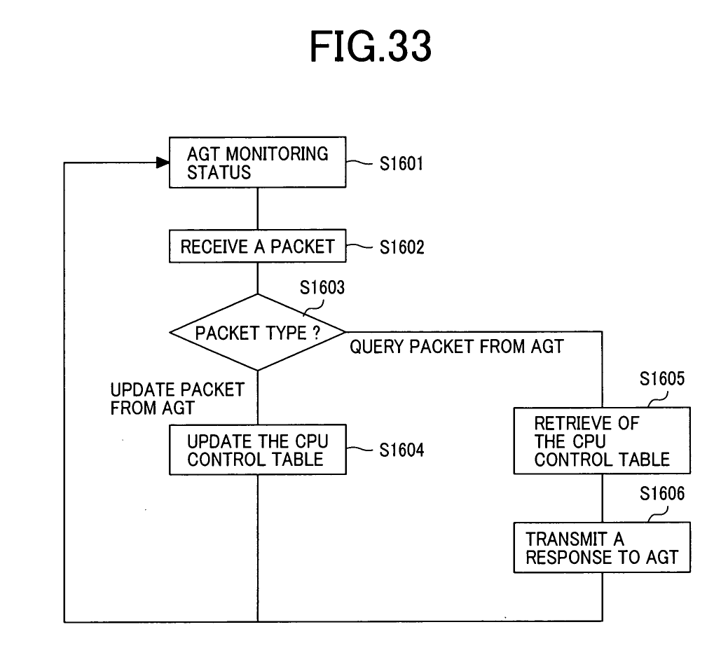

FIG. 33 is a flow chart of an authentication agent program of the AGT control node 80F. The AGT control node 80F is in an AGT monitoring status (S1601). The AGT control node 80F, upon receiving a packet in the AGT monitoring status (S1602), judges whether the packet type is of an update packet or a query packet (S1603). The update packet is a packet that is transmitted by all AGTs 80A to 80E at a prescribed interval to the AGT control node 80F. The update packet contains information on the status of the CPUs 120 of all the AGTs.

If the packet received by the AGT control node 80F is of an update packet, the AGT control node 80F updates the status 832 of the CPU control table 830 based on the information contained in the update packet (S1604). On the other hand, when the packet received by the AGT control node 80F is a query packet, the AGT control node 80F retrieves for AGTs in which the status 832 of the CPU control table 830 is “low load” and choose an AGT that is suitable for executing authentication processing (S1605). Next, the AGT control node 80F transmits a response packet containing identification information on the chosen AGT to the AGT 80A (S1606) and returns to the AGT monitoring status (S1601).

With the embodiment, as described above, time required for choosing an AGT 80 that is suitable for executing authentication processing will not increase since the AGT control node 80F chooses an AGT 80 that is suitable for executing the authentication processing. In other words, since the AGT control node 80F performs processing such that it chooses in a domain an AGT 80 being in a low-load status, not the AGT 80A whose CPU 120 is in a high-load status, it is possible to prevent deterioration in the access processing capability (access throughput) of the entire network.

[Sixth Embodiment]

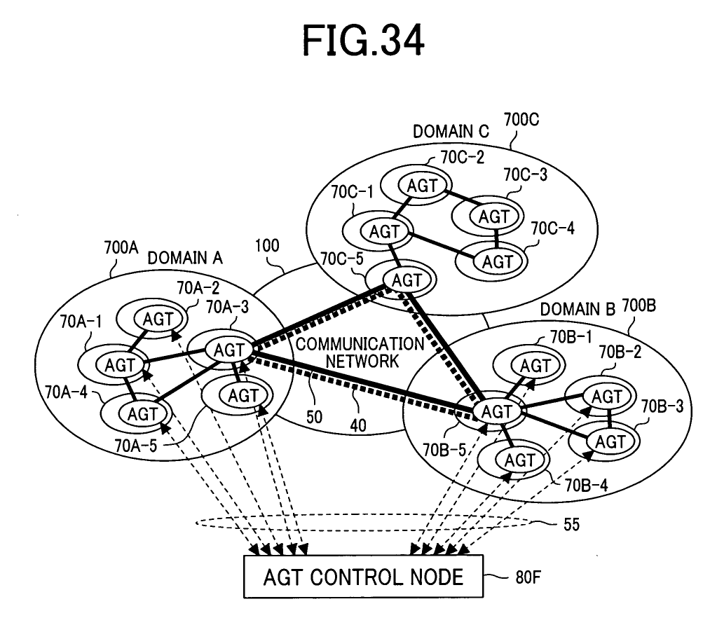

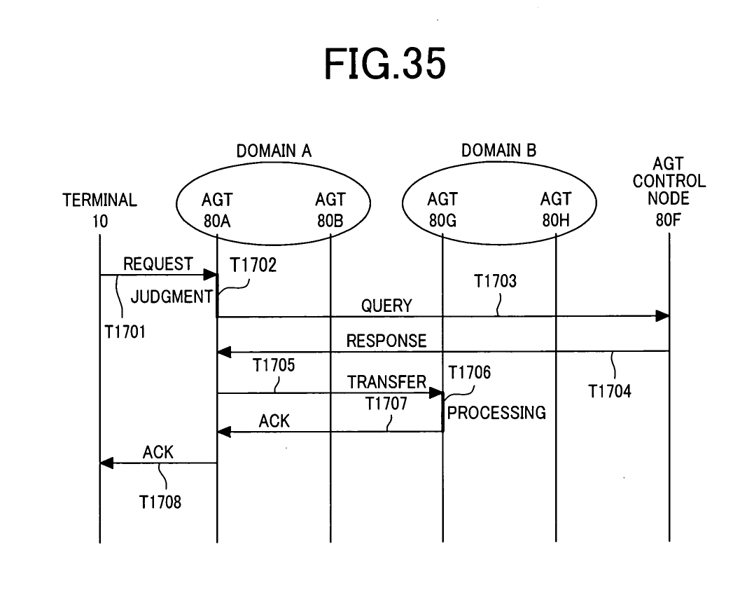

A Sixth embodiment will be described with reference to FIGS. 34 and 35. In the embodiment, the AGT control node 80F also holds information on the CPU status of AGTs in other domains 700. It should be noted that, the same configurations as those referred to for the third embodiment are given the same reference numerals, and redundant descriptions thereof will be omitted.

FIG. 34 is a system configuration diagram. The system configuration illustrated in FIG. 34 is almost the same as that of the third embodiment illustrated in FIG. 16. In the embodiment, however, the AGT 80A and the AGT 80B shall belong to a domain A and the AGT 80G and the AGT 80H shall belong to a domain B. The AGT control node 80F is logically connected to all AGTs which belong to the domain A (700A) and the domain B (700B) via the dedicated line 55. The dedicated line 55 may be of a fixed line or of a wireless line.

All AGTs that belong to the domain A and domain B transmit an update packet at a prescribed interval to the AGT control node 80F. The method for updating the CPU control table 830 by the AGT control node 80F is the same as that of the fifth embodiment referred to earlier. The CPU control table of the sixth embodiment holds information on the status of the CPUs 120 included in all AGTs in the domains A and B. The other components are configured the same as those of the CPU control table 830 (FIG. 30) of the fifth embodiment.

FIG. 35 is a sequence diagram describing the respective operations of devices in the sixth embodiment. The terminal 10 transmits a request packet to the AGT 80A (T1701). The AGT 80A, upon receiving a request packet, judges load on the CPU 120 included in the AGT 80A (T1702). With the status illustrated in FIG. 35, the AGT 80A judges that the CPU 120 is in a high-load status. At this time, since it takes time when the AGT 80A executes authentication processing, which deteriorates the throughput of the network, the AGT 80A tries to cause another AGT to carry out the authentication processing for the AGT 80A. Then, the AGT 80A transmits a query packet to the AGT control node 80F (T1703).

The AGT control node 80F, upon receiving the query packet, chooses an AGT that is suitable for executing authentication processing by referring to the status 832 of the CPU control table 830 and transmits a response packet to an AGT 80A that includes the identifier of the AGT thus chosen (T1704). The AGT 80A, upon receiving the response packet, transfers the request packet to the AGT 80G chosen by the AGT control node 80F (T1705). The AGT 80G, upon receiving the request packet, executes authentication processing (T1706) and transmits an ACK packet containing an authentication result to the AGT 80A (T1707).

The AGT 80A, upon receiving the ACK packet, transfers the ACK packet to the terminal 10 (T1708). It should be noted that, in the fourth embodiment, the AGT control node 80F is connected to all AGTs that belong to the domain A (700A) and domain B (700B). However, it is of course possible that the AGT control node 80F may further have connections with all AGTs belonging to a domain C (700C).

With the sixth embodiment, as described above, in addition to the advantages of the fifth embodiment referred to earlier, since the AGT control node 80F chooses an AGT 80 that is suitable for executing authentication processing among a plurality of domains, time required for choosing the AGT 80 that is suitable for executing the authentication processing will not increase.

In addition, since the AGT control node 80F holds information on the status of the CPU 120 included in all AGTs 80 that belong to other domains, the range for choosing the AGT that executes authentication processing becomes wider, which enables choosing of a more suitable AGT and preventing deterioration in the access processing capability (access throughput) of the entire network.

We claim:

1. A communication node which configures a domain with a terminal, comprising:
a database which stores registration information of a terminal and includes initial information and differential information on a terminal that makes participation later;
wherein said differential information is transferred to a communication node in another domain when movement of a terminal under control thereof to another domain is detected.

2. A communication node according to claim 1,
wherein said communication node in said another domain is directly connected to said communication node.

3. A communication node which configures a communication network, said communication node comprising:
a database including initial information on registration status of a terminal and differential information of another terminal which participates later;
wherein, when another differential information is transmitted from another communication node which configures a communication network, said differential information is updated by using said another differential information.

4. A communication node which configures a communication network, said communication node comprising:
a database including registration status of a terminal;
wherein, when capturing a change transfer destination message from a terminal under control of said communication node to a home agent, said communication node retrieves for said terminal by referring to said database, and
if said terminal is not registered in said database, said communication node inquires of said home agent a transfer destination address of said terminal.

5. A communication node which configures a communication network, said communication node comprising:
a database including registration status of a terminal;
wherein, when capturing a change transfer destination message from a terminal under control of said communication node to a home agent, said communication node retrieves for said terminal by referring to said database, and
if said terminal is registered in said database, said communication node transfers said message to change a transfer destination, to said home agent.

6. A communication network comprising:
a first communication node that controls a first domain;
a second communication node that controls a second domain; and
a home agent;
wherein said first communication node includes a first database that has initial information of registration status of a terminal and a first differential information of a terminal that participated later,
said second communication node includes a second database that has initial information of registration status of a terminal and a second differential information of a terminal that participates later; and
wherein, when said second communication node captures a change transfer destination message which is delivered to said home agent when a terminal moved to said second domain from said first domain, said first differential information owned by said first communication node is transferred to said second communication node, and said second differential information is updated.

7. A method for updating a registration information database of a terminal that is stored by a first communication node, said updating method comprising the steps of:
detecting a change transfer destination message that is transmitted by a moved-in terminal under control;
retrieving for an address of a second communication node that controls a movement-source domain of said terminal;
transmitting an update request of a database to said second communication node; and
rewriting said database by using the database information of said second communication node that are transmitted to said second communication node.

8. A communication system comprising:
a plurality of communication nodes each including a processor for executing authentication processing according to an authentication request from a terminal, said communication nodes being connected logically to one another;
wherein said communication nodes include a first communication node that receives said authentication request and a second communication node connected logically to said first communication node; and
wherein said first communication node:
upon receiving an authentication request from said terminal, judges the load status of a processor of said first communication node;
if said processor is in a high-load status, transfers said authentication request to said second communication node; and
if said processor is in a low-load status, executes authentication processing from said terminal within said first communication node.

9. A communication system according to claim 8,
wherein said communication system includes a plurality of domains to which said plurality of communication nodes belong;
part of said communication nodes are connected in a loop formed with unicursal polygons within said domains; and
at least one of said communication nodes that are connected in a loop formed with unicursal polygons is connected to said communication nodes that belong to other domains via a communication network.

10. A communication system according to claim 8,
wherein said first communication node, when judging that a processor of said first communication node is in a high-load status, makes a query on a load status of said processor of said second communication node to said communication node;
said second communication node, upon receiving said query, transmits a response containing the load status of said processor of said second communication node; and
said first communication node, based on said response, identifies communication nodes where said processor of said second communication node is in a low-load status, and transfers said authentication request to a second communication node having the shortest time from transmitting said query to receiving a response, among said communication nodes that have been identified to be in a low-load status.

11. A communication system according to claim 8,
further comprising a control node which controls information on the load status of said processor of said communication node;
wherein said first communication node, when judging that said processor of said first communication node is in a high-load status, makes a query on the load status of said processor of said second communication node to said control node;
said control node, upon receiving said query, chooses said second communication node wherein said processor is in a low-load status and transmits a response containing information on said chosen second communication node to said first communication node; and
said first communication node, upon receiving said response, transfers said authentication request to said chosen second communication node.

12. A communication system according to claim 11,
further comprising a first domain to which said first communication node and said second communication node belong, and a second domain to which at least said communication node belongs;
wherein said control node controls information on the load status of said respective processors of said communication node which belongs to said first domain and said communication node which belongs to said second domain.

13. A communication node comprising:
a processor which executes authentication processing according to an authentication request from a terminal;
wherein said communication node, upon receiving said authentication request from said terminal, judges the load status of said processor,
if said processor is in a high-load status, transfers said authentication request to another communication node which is logically connected to said communication node, and
if said processor is in a low-load status, executes said authentication processing from said terminal within said communication node.

14. A communication node according to claim 13,
wherein part of said communication nodes are connected each other in a loop formed with unicursal polygons within a domain to which a plurality of said communication nodes belong; and
at least a communication node among said communication nodes that are connected to each other in a loop formed with unicursal polygons is connected to said communication node which belongs to another domain via a communication network.

15. A communication node according to claim 13,
wherein said communication node, when judging that said processor is in a high-load status, makes a query on a processor of said another communication node to said another communication node;
said another communication node, upon receiving said query, transmits a response containing load status of said processor of said another communication node to said communication node; and
said communication node, based on said response, identifies a second communication node where said processor of said second communication node is in a low-load status, and transfers said authentication request to another communication node having the shortest time from transmitting said query to receiving a response, among said communication nodes that have been identified to be in a low-load status.

16. A communication node according to claim 13,
wherein said communication node, when judging that said processor of said communication node is in a high-load status, makes a query on the load status of said processor of said communication node to a control node which controls information on the load status of said processor of said communication node;
said control node, upon receiving said query, chooses a communication node wherein said processor is in a low-load status and transmits a response containing information on said chosen communication node to said communication node; and
said communication node, upon receiving said response, transfers said authentication request to said chosen communication node.

17. A communication node according to claim 16,
wherein said communication node is provided in each of a plurality of domains to each of which a plurality of communication nodes belong; and,
wherein said control node controls information on load status of said processor included in each of said communication nodes each of which belongs to said plurality of domains.
